(19) United States
(12) Patent Application Publication
(10) Pub. No.: US 2008/0049239 A1
(43) Pub. Date: Feb. 28, 2008

(54) MULTIPLE TONE DISPLAY SYSTEM

(76) Inventors: Yutaka Chiaki, Yokohama (JP); Yoshiaki Takada, Yokohama (JP); Yuichiro Kimura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/626,404

(22) Filed: Jan. 24, 2007

(30) Foreign Application Priority Data
Aug. 22, 2006 (JP) JP2006-224841

(51) Int. Cl. G06F 15/00

(52) U.S. Cl. 358/1.9

(57) ABSTRACT

A technology capable of reducing false contours and others in accordance with inclinations of various gradations and capable of improving image quality when moving images are displayed in a multiple tone display system is provided. In this display system, in addition to a movement amount (MV) and a digit change signal (RK) and the like, an edge amount (GR) which expresses a size of inclination of gradation is detected in a multiple tone processing unit. Then, in accordance with them, an appropriate process is selected and executed in a false contour processing unit from plural kinds of processes for reducing the false contours in moving images including a multiple tone process.

### CROSS-REFERENCE TO RELATED APPLICATION

The present application claims priority from Japanese Patent Application No. JP 2006-224841 filed on Aug. 22, 2006, the content of which is hereby incorporated by reference into this application.

### TECHNICAL FIELD OF THE INVENTION

The present invention relates to a technology for a multiple tone display system (digital display system) such as a plasma display system (PDP system), in which control and processing for multiple tone (multiply toned) display are performed to a display panel. More specifically, it relates to the signal processing for reducing the false contours (pseudo contours) in order to improve image quality of video images (moving images).

### BACKGROUND OF THE INVENTION

In conventional display systems such as a PDP system, an LCD (liquid crystal display system), an organic EL display and the like, multiple tone display control is performed on the basis of input image (video image) signals, and moving images by multiple tone pixels are displayed on a display panel. In a so-called sub field method, one field (also referred to as frame) corresponding to the display area (screen) and period of the display panel is divided into a plurality of sub fields (also referred to as sub frames) weighted with a predetermined luminance (brightness) ratio for tone (grayscale) expression. In this structure, the multiple tone display control is carried out by the encoding into combinations of lighting state (ON) and non lighting state (OFF) of pixels (display cells) in unit of sub field, in other words, by the conversion into sub field data.

Though it depends on the screen size, the number of pixels, and video contents and the like, when following an object moving over a certain speed in the video images of multiple tone display in the conventional PDP system, a phenomenon called false contour is recognized.

As one of the method for reducing the false contour, the superposition method is known. In this method, two SF lighting tables (SF conversion tables) are superposed spatially in a zigzag manner.

Further, as another method, the distribution method of false contour is known. As this distribution method, the error diffusing method, the pixel value replacement method described in Japanese Patent Application Laid-Open Publication No. 2005-301302 (Patent Document 1), the SF conversion switching method described in Japanese Patent Application Laid-Open Publication No. 2003-15587 (Patent Document 2) and others are proposed. In the SF conversion switching method, switching is performed depending on image patterns based on a plurality of SF conversion LUTs (lookup tables).

Furthermore, as still another method, the path switching method as described in Japanese Patent No. 3322809 (Patent Document 3) and Japanese Patent No. 3365630 (Patent Document 4) is known. In the path switching method, the main path and the sub path to be the paths of tone processing and the like are switched so as to prevent the false contours.

Still further, as improved methods of the path switching method, the method in which the amount of dither modulation is changed depending on the movement amount (movement applied dither method) and the method in which paths are switched depending on the movement amount (described in Japanese Patent Application Laid-Open Publication No. 2006-64743 (Patent Document 5)) are also proposed.

### SUMMARY OF THE INVENTION

The conventional methods for reducing false contours described above have problems as follows. That is, in the superposition method, hatched (zigzag) noises are recognized in moving images. The hatched noises are difficult to be recognized in the case of relatively fast movement because the view point moves over a plurality of pixels and the noises are cancelled by one another, but in the case of slow movement, the hatched noises are recognized.

With respect to the distribution method, in any of the error diffusing method, the pixel value replacement method, and the SF conversion switching method, the effects thereof differ depending on the areas of gradation in video images. That is, in a portion with moderate gradation, an effect can be achieved to the false contours that are recognized in the shape of level lines, but in a contour portion where the edge amount is large, in other words, in a portion with sharp gradation, no effect can be achieved. Note that the gradation is associated with the inclination of tone between pixels and the edge amount (the change amount of luminance).

In the path switching method, in spite of the smooth tone expression of the main path, the granular noise due to the error diffusion processing in the sub path is large. In a portion with sharp gradation, the granular noises are not conspicuous, but in an image area with moderate gradation, a switching shock inappropriately occurs in the portion where a main path is switched to a sub path.

In the movement applied dither method, dither patterns are hard to be recognized in a gradation portion, but when an area where movement amount is over a specified value is detected widely in a portion with extremely moderate gradation, hatched noises due to the dithering become conspicuous in a wide area.

Further, in the reduction of false contours using the conventional path switching method, accuracy for movement detection is required, and switching from the main path to the sub path cannot be made at the time when the switching should be made, or on the contrary, switching is made at the time when the switching should not be made and so forth. Thus, it is extremely difficult to change the paths in accordance with the movement amounts.

As described above, although several methods for reducing false contours have been proposed, the effects thereof differ depending on the inclination of gradation in video images, and there has not been any method capable of coping with all the gradation inclinations heretofore, which has been a problem in the prior art.

The present invention has been made in consideration of the above problem in the prior art, and an object of the present invention is to provide a technology capable of reducing distortion and noises due to false contours and improving the image quality, in accordance with various gradation inclinations when displaying moving images, in a display system such as a PDP system where moving images are displayed by multiple tone control.

The typical ones of the inventions disclosed in this application will be briefly described as follows. In order to achieve the object mentioned above, according to one aspect of the present invention, a technology for a display system such as a PDP system in which control and processing for multiple tone display are performed by the sub field method on the basis of input image signals to display moving images on a display panel is to be provided, and it is characterized by comprising the following technical means. In this display system, for example, a circuit for controlling and processing the multiple tone display is formed in a circuit unit for driving and controlling the display panel.

(1) In this display system, in addition to movement amount and the like in moving images of a display object, gradation which has not been sufficiently considered in the prior art is taken into consideration, and an appropriate process is selected and executed in accordance with them from among various types of processes for reducing the false contours of moving images including multiple tone process. In this display system, the inclination degrees and partial areas of the gradation in moving images of the display object are detected and determined, and edge amount (GR) between adjacent pixels is calculated and used as the amount corresponding to the size of gradation inclination.

This display system is a multiple tone display system, in which a field corresponding to the display area and period by pixels in a display panel is divided into a plurality of sub fields weighted with brightness, and multiple-tone moving images are displayed on the display panel by the encoding into combinations of lighting ON/OFF in unit of sub field on the basis of input image signals in accordance with tones of pixels of the field. This display system comprises: means for detecting and outputting the movement part of input image signals and the movement amount (MV) showing the size thereof (movement detecting unit); means for detecting and outputting the edge amount (GR) showing the size of inclination of gradation of input image signals (pattern detecting unit); and means for detecting digit changes (digit crossover) such as carry and borrow of input image signals between adjacent pixels and outputting digit change signals (RK) expressing them (digit change detecting unit). This display system further comprises: signal processing means which, under the condition on the basis of MV, GR, and RK where MV is a specified value or more and RK is a value showing the presence of a digit change, selects a process according to GR among from various types of processes for reducing false contours and executes the process; and means which inputs the output of the signal processing means and converts the same into data of the encoding in accordance with a specified table and outputs the same to the display panel. As the digit change signal in the digit change detecting unit, for example, when the digit change detecting unit detects a digit change, it changes the logic value thereof from “0” to “1” and then outputs the same.

(2) Further, this display system has the following structure. That is, this display system comprises: means for detecting and outputting the movement amount (MV) of input image signals (movement detecting unit); means for detecting and outputting the edge amount (GR) of input image signals (pattern detecting unit); and means for detecting digit changes between adjacent pixels and outputting digit change signals (RK) expressing the same at least in pixels where the digit changes are detected and the peripheral thereof (adjacent pixels) (digit change detecting unit). This display system further comprises the following means as the means for inputting input image signals and switching a plurality of paths in the processing of data to be outputted to a display panel and the drive control unit thereof. That is, it comprises: first, as a main path that prioritizes the number of tones in an area where false contours are not recognized, main path means which outputs a first image signal (MP) after multiple tome processing; second, as a first sub path (sub path A) for diffusing false contours, first sub path means which outputs a second image signal (SPA) after modulation process; and third, as a second sub path (sub path B) which selects and displays a sub field where false contours are hard to occur (sub field lighting pattern), second sub path means which outputs a third image signal (SPB) with a smaller number of tones than that of the main path. Further, this display system inputs the second image signal (MP) of the output of the main path and outputs the digit change signal (RK) in the digit change detecting unit. Further, this display system comprises: switching means which inputs MV, GR, and RK and selects and outputs one of MP, SPA and SPB on the basis of MV, GR, and RK; and converting means which inputs the output of the switching means and converts it into data of the encoding of combinations of lighting ON/OFF for each sub field (field and sub field data) in accordance with the table where the predetermined patterns of combinations of sub fields are recorded and then outputs the same.

Furthermore, in this display system, the switching means selects the second sub path under a first condition where MV is a moving image portion with a specified value or more and GR is larger than a first threshold (EG), that is, in an edge (contour) portion where the inclination of gradation is sharp, it selects the first sub path under a second condition where MV is a moving image portion with a specified value or more and GR is within a specified range (when it is a second threshold value (FLT) or more and less than the first threshold value (EG)) and is neither an edge portion nor flat, that is, in a gradation portion with a certain degree of inclination, and it selects a main path under a third condition other than the first and second conditions, that is, in a flat portion or the like. By this means, false contours in moving images can be reduced or prevented.

The effects obtained by typical aspects of the present invention will be briefly described below. According to the present invention, in a display system such as a PDP system where moving images are displayed by multiple tone control, it is possible to provide a technology capable of reducing distortion and noises due to false contours in accordance with various gradation inclinations when moving images are displayed, thereby improving image quality.

Further, in particular, it is possible to diffuse false contours occurring in gradation portion of images by the dithering process, and it is possible to reduce hatched noises in a portion where gradation is moderate by the error diffusion process, and further, it is also possible to reduce or prevent false contours occurring at a edge portion where gradation is sharp by using the sub field lighting pattern where false contours are hard to occur.

### BRIEF DESCRIPTIONS OF THE DRAWINGS

FIG. 1 is a diagram showing the entire structure of a PDP system which is a display system having multiple tone processing means according to an embodiment of the present invention;

FIG. 2 is a diagram showing an example of the structure of a display unit (PDP) in a display system according to an embodiment of the present invention;

FIG. 3 is a diagram showing the structure of field and SF in a display system according to an embodiment of the present invention;

FIG. 4 is a diagram showing a data of SF conversion table in a display system according to an embodiment of the present invention;

FIG. 5 is a diagram showing the structure of a multiple tone processing unit in a display system according to a first embodiment of the present invention;

FIG. 6 is a diagram showing the structure of a multiple tone processing unit in a display system according to a second embodiment of the present invention;

FIG. 7 is a diagram showing the control of switching of processes in a multiple tone processing unit in a display system according to the second embodiment of the present invention;

FIG. 8 is a diagram showing the transition of data conversion in a main path, a sub path A, and a sub path B in a display system according to the second embodiment and others of the present invention;

FIG. 9 is a diagram showing a modified example of the structure of the sub path A unit in a display system according to the second embodiment of the present invention;

FIG. 10 is a diagram showing gain characteristics of an SA1 distortion correction gain unit in the modified example of the sub path A unit in a display system according to the second embodiment of the present invention;

FIG. 11 is a diagram showing gain characteristics of an SB distortion correction gain unit in the sub path B unit in a display system according to the second embodiment and others of the present invention;

FIG. 12 is a diagram showing the structure of a pattern detecting unit in a display system according to the second embodiment of the present invention;

FIG. 13A is a diagram showing the structure of a pattern coding unit of the pattern detecting unit in the case of DEF≠0 in a display system according to the second embodiment of the present invention;

FIG. 13B is a diagram showing the structure of a pattern coding unit of the pattern detecting unit in the case of DEF≠0 in a display system according to the second embodiment of the present invention;

FIG. 14 is a diagram showing the detection method of an edge amount in the pattern detecting unit in a display system according to the second embodiment of the present invention;

FIG. 15 is a diagram showing the structure of a digit change detecting unit in a display system according to the second embodiment of the present invention;

FIG. 16 is a diagram showing the configuration of the coding of a digit coding unit of a digit change detecting unit in a display system according to the second embodiment of the present invention;

FIG. 17 is a diagram showing an example of the structure of a dithering unit (M dithering unit of the main path, M2 dithering unit of the main path, SA2 dithering unit of the sub path A1) in display systems according to respective embodiments (second, third, and fourth embodiments) of the present invention;

FIG. 18A is a diagram showing a modulation process by dithering process in the dithering unit in a display system according to respective embodiments (second, third, and fourth embodiments) of the present invention;

FIG. 18B is a diagram showing a modulation process by dithering process in the dithering unit in a display system according to respective embodiments (second, third, and fourth embodiments) of the present invention;

FIG. 19A is a diagram showing a relation of a dithering amount (Mi) to an input tone (i) in the M dithering unit in a display system according to the second embodiment and others of the present invention;

FIG. 19B is a diagram showing another relation of a dithering amount (Mi) to an input tone (i) in the M dithering unit in a display system according to the second embodiment and others of the present invention;

FIG. 19C is a diagram showing another relation of a dithering amount (Mi) to an input tone (i) in the M dithering unit in a display system according to the second embodiment and others of the present invention;

FIG. 19D is a diagram showing another relation of a dithering amount (Mi) to an input tone (i) in the M dithering unit in a display system according to the second embodiment and others of the present invention;

FIG. 20 is a diagram showing the structure of an M error diffusing unit in the main path in a display system according to the second embodiment of the present invention;

FIG. 21 is a diagram showing the diffusing method of the M error diffusing unit in the main path in a display system according to the second embodiment of the present invention;

FIG. 22 is a diagram showing the structure of a distortion correction gain unit (SB distortion correction gain unit and the like) according to respective embodiments (second, third, and fourth embodiments) of the present invention;

FIG. 23A is a diagram showing an effect (part 1) of the dithering process in the SA dithering unit of the sub path A unit in a display system according to the second embodiment of the present invention;

FIG. 23B is a diagram showing an effect (part 1) of the dithering process in the SA dithering unit of the sub path A unit in a display system according to the second embodiment of the present invention;

FIG. 23C is a diagram showing an effect (part 1) of the dithering process in the SA dithering unit of the sub path A unit in a display system according to the second embodiment of the present invention;

FIG. 24A is a diagram showing another effect (part 2) of the dithering process in the SA dithering unit of the sub path A unit in a display system according to the second embodiment of the present invention;

FIG. 24B is a diagram showing another effect (part 2) of the dithering process in the SA dithering unit of the sub path A unit in a display system according to the second embodiment of the present invention;

FIG. 24C is a diagram showing another effect (part 2) of the dithering process in the SA dithering unit of the sub path A unit in a display system according to the second embodiment of the present invention;

FIG. 25A is a diagram showing an effect (part 1) of the error diffusion process in the SA error diffusing unit of the sub path A unit in a display system according to the second embodiment of the present invention;

FIG. 25B is a diagram showing an effect (part 1) of the error diffusion process in the SA error diffusing unit of the sub path A unit in a display system according to the second embodiment of the present invention;

FIG. 25C is a diagram showing an effect (part 1) of the error diffusion process in the SA error diffusing unit of the sub path A unit in a display system according to the second embodiment of the present invention;

FIG. 26A is a diagram showing another effect (part 2) of the error diffusion process in the SA error diffusing unit of the sub path A unit in a display system according to the second embodiment of the present invention;

FIG. 26B is a diagram showing another effect (part 2) of the error diffusion process in the SA error diffusing unit of the sub path A unit in a display system according to the second embodiment of the present invention;

FIG. 26C is a diagram showing another effect (part 2) of the error diffusion process in the SA error diffusing unit of the sub path A unit in a display system according to the second embodiment of the present invention;

FIG. 27 is a diagram showing the principle of occurrence (part 1) of false contours which are the problem in a conventional display system;

FIG. 28 is a diagram showing the principle of occurrence (part 2) of false contours which are the problem in a conventional display system;

FIG. 29 is a diagram showing the principle of occurrence (part 3) of false contours which are the problem in a conventional display system;

FIG. 30 is a diagram showing the effect (part 1) of reduction of false contours by the process of the sub path B unit in the second embodiment and others of the present invention;

FIG. 31 is a diagram showing the effect (part 2) of reduction of false contours by the process of the sub path B unit in the second embodiment and others of the present invention;

FIG. 32 is a diagram showing the control of the switching of processes in a multiple tone processing unit in a modified example of a display system according to the second embodiment of the present invention;

FIG. 33 is a diagram showing the structure of a multiple tone processing unit according to a third embodiment of the present invention;

FIG. 34 is a diagram showing the control of the switching of processes in a multiple tone processing unit in a display system according to the third embodiment of the present invention;

FIG. 35A is a diagram showing a relation between the edge amount and the modulation coefficient in the SA2 dithering unit in the multiple tone processing unit in a display system according to the third embodiment of the present invention;

FIG. 35B is a diagram showing another relation between the edge amount and the modulation coefficient in the SA2 dithering unit in the multiple tone processing unit in a display system according to the third embodiment of the present invention;

FIG. 35C is a diagram showing another relation between the edge amount and the modulation coefficient in the SA2 dithering unit in the multiple tone processing unit in a display system according to the third embodiment of the present invention;

FIG. 35D is a diagram showing another relation between the edge amount and the modulation coefficient in the SA2 dithering unit in the multiple tone processing unit in a display system according to the third embodiment of the present invention;

FIG. 36 is a diagram showing the structure of the sub path A2 unit in a modified example of the display system according to the third embodiment of the present invention;

FIG. 37 is a diagram showing the control of the switching of the processes in a modified example of the display system according to the third embodiment of the present invention;

FIG. 38 is a diagram showing the structure of a multiple tone processing unit according to a fourth embodiment of the present invention; and

FIG. 39 is a diagram showing the control of the switching of processes in the multiple tone processing unit according to the fourth embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

<False Contour>

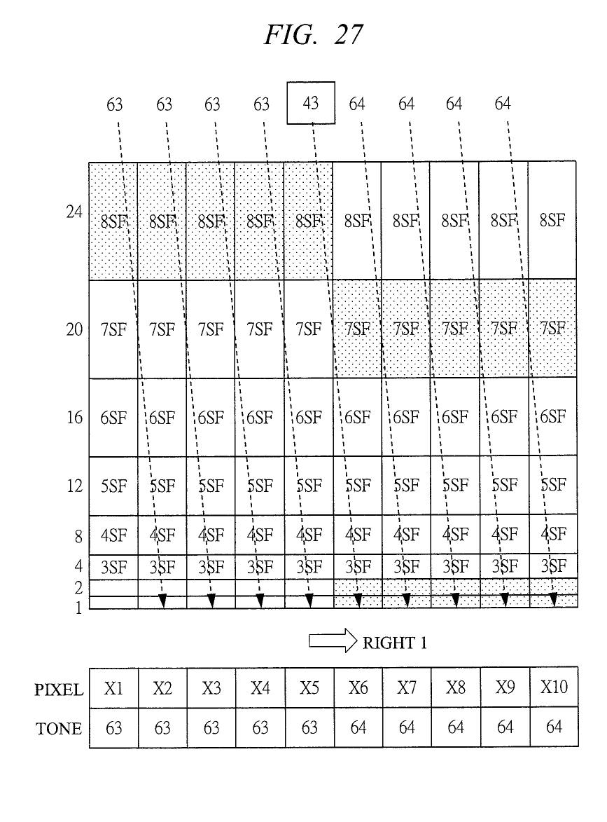

First, false contours which occur in a conventional PDP system will be briefly described with reference to FIG. 27 to FIG. 29. As an example, the sub field (SF) lighting state of continuous horizontal 10 pixels is shown.

In FIG. 27, the tone (luminance) of each of the pixels (X1 to X10) is 63, 63, 63, 63, 63, 64, 64, 64, 64, and 64 from the left. That is, the five pixels on the left side show 63, and the five pixels on the right side show 64. The case of an image (picture) where the area of pixel values of the continuous ten pixels moves by one pixel in one field for example in the right direction will be described. In this case, since a viewer follow the movement and moves his view point at the speed of one pixel per one field, it crosses over SF as shown in dotted-line arrows. As a result, the luminance recognized becomes 63, 63, 63, 63, 43, 64, 64, 64, and 64 from the left. More specifically, a dark luminance (tone) as 43 different from 63 of still image (original tone value) is expressed at the fifth pixel from the left between 63 and 64, and this is recognized as a false contour.

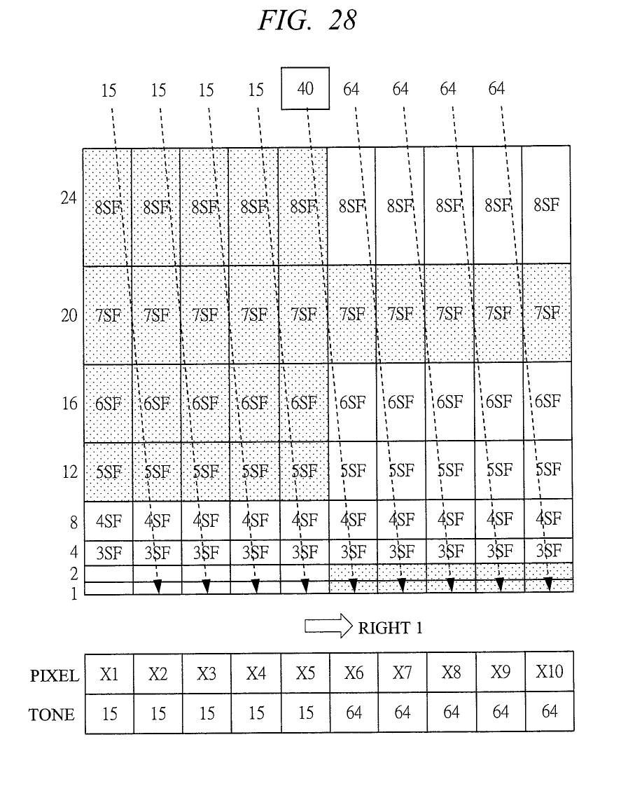

Further, a case of another false contour is shown in FIG. 28. It shows an image where an edge (contour) portion in which the tone of the five pixels on the left side is 15 and the tone of the five pixels on the right side is 64 in horizontal ten pixels (X1 to X10) moves by one pixel in one field in the right direction. At the fifth pixel from the left, luminance (tone 40) between tones 15 and 64 is recognized. That is, the edge portion is shown blurred.

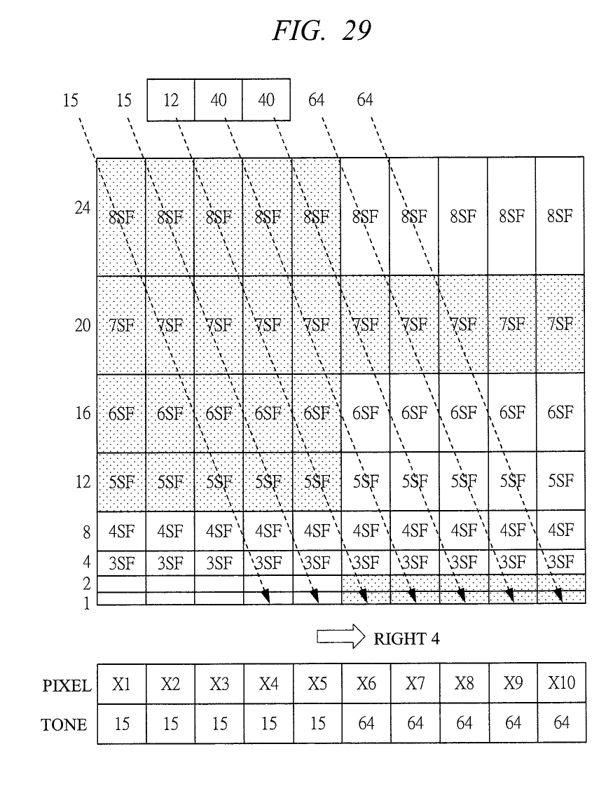

Further, a case of another false contour is shown in FIG. 29. It shows an image where an edge (contour) portion in which the tone of the five pixels on the left side is 15 and the tone of the five pixels on the right side is 64 in horizontal ten pixels (X1 to X10) moves by four pixels in one field in the right direction. At the third to fifth pixels from the left, luminance (tones of 12, 40 and 40) different from the original ones is recognized. That is, the edge portion is shown expanded and more blurred than in that of the case of FIG. 28.

### First Embodiment

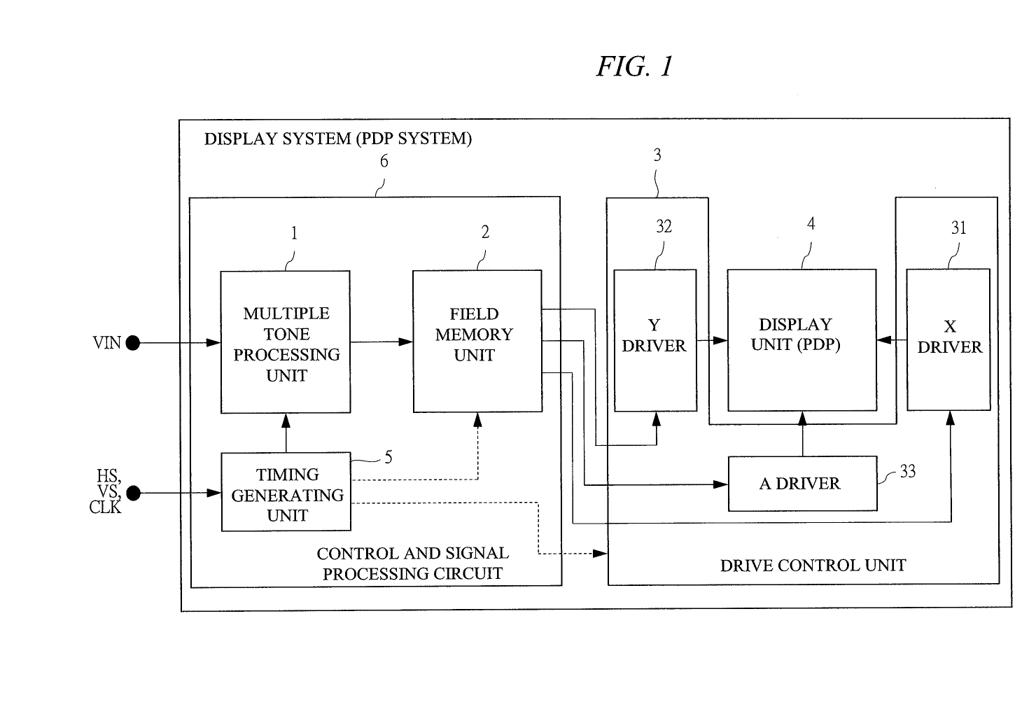

A display system according to a first embodiment will be described below with reference to FIG. 1 to FIG. 5 and others. The feature of the first embodiment lies in that a signal process for reducing false contours are selected and executed for input image signals, on the basis of detection of movement, gradation, and digit change, especially in accordance with gradation (edge amount) in its multiple tone processing unit.

<PDP System>

First, the entire structure of a PDP system as a display system including multiple tone processing means in respective embodiments will be described with reference to FIG. 1. The present PDP system includes a multiple tone processing unit 1, a field memory unit 2, a drive control unit (driver) 3, a display unit (PDP) 4, and a timing generating unit 5. The multiple tone processing unit 1, the field memory unit 2, and the timing generating unit 5 are provided in a control and signal processing circuit 6 and control the drive control unit 3 and others.

The multiple tone processing unit 1 performs the multiple tone process for outputting data (field and SF data) of multiple tone pixels to the display unit 4 and the drive control unit 3 on the basis of input image signals (video signals) VIN and outputs the data. The field memory unit 2 inputs and temporarily stores the output data of the multiple tone processing unit 1 and outputs the data of all screen for each SF in the next field. The drive control unit 3 inputs data from the field memory unit 2 and controls the display on the display unit 4. The timing generating unit 5 inputs a vertical sync signal VS, a horizontal sync signal HS, a clock signal CLK and others, and generates and outputs timing signals required to control the multiple tone processing unit 1, the field memory unit 2, the drive control unit 3, the display unit 4 and others.

The drive control unit 3 has, for example, an X driver 31 that drives X electrodes of the display unit 4 by applying voltage, a Y driver 32 that drives Y electrodes of the display unit 4 by applying voltage, and an A driver (address driver) 33 that drives address electrodes of the display unit 4 by applying voltage. The display unit 4 is, for example, a 3-electrode AC PDP having X and Y electrodes for generating sustain discharge for display and address electrodes for address operation.

<PDP>

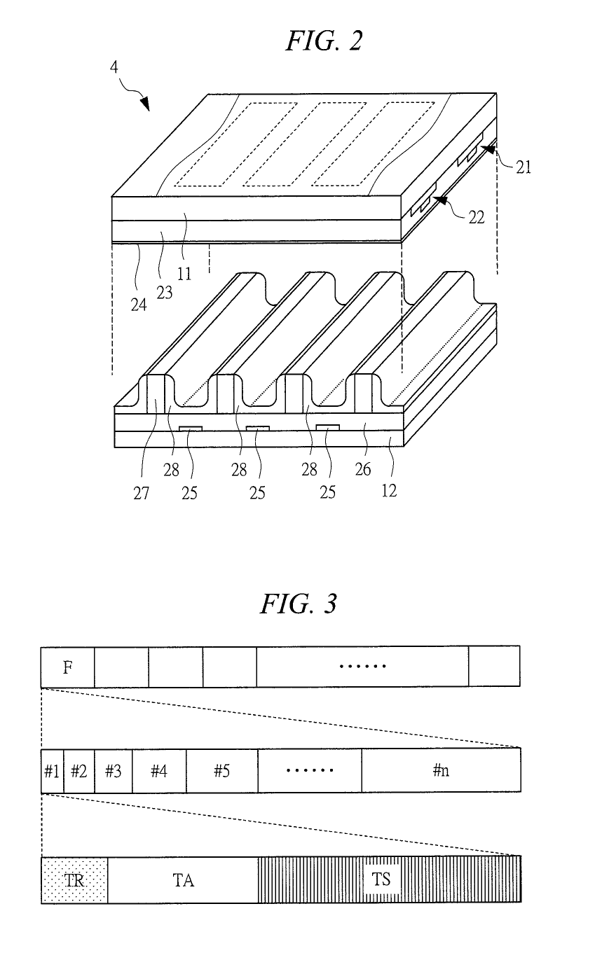

Next, an example of the panel structure of the display unit (PDP) 4 will be described with reference to FIG. 2. FIG. 2 shows a part corresponding to a pixel. The display unit (PDP) 4 is composed of a front substrate 11 and a rear substrate 12 mainly made of light emitting glass and assembled so as to oppose each other, and the circumferential portion thereof is sealed and the space therebetween is filled with discharge gas.

On the front substrate 11, a plurality of X electrodes 21 and Y electrodes 22 for generating sustain discharge are formed in parallel in the horizontal (row) direction and alternately disposed in the vertical (column) direction. These electrodes are covered with a dielectric layer 23 and the surface thereof is covered with a protective layer 24 of MgO or the like. On the rear substrate 12, a plurality of address electrodes 25 are formed so as to extend in parallel in the vertical direction roughly perpendicular to the X electrodes 21 and the Y electrodes 22, and the address electrodes 25 are covered with a dielectric layer 26. On the dielectric layer 26, barrier ribs 27 expanding in the vertical direction are formed on both sides of the address electrode 25, and they partition the spaces in the column direction. Further, phosphors 28 that are excited by ultraviolet ray to generate visible lights of colors of red (R), green (G), and blue (B) are applied on the dielectric layer 26 on the address electrode 25 and on the side surfaces of the barrier rib 27.

Display rows are formed so as to correspond to the pair of the X electrode 21 and the Y electrode 22, and display columns and cells are formed so as to correspond to the intersections with the address electrode 25. A pixel is formed from a set of cells of R, G, and B. The display area of the display unit 4 is formed from the cells arranged in matrix, and it is associated with the field and SF to be the unit of the display. For PDP, there are various types of structures depending on the drive method and the like.

<Field and SF>

Next, as the basic of the drive control of the display unit (PDP) 4, the drive method of the field and SF will be described with reference to FIG. 3. One field period (F) is expressed in, for example, 1/60 second. The field period (F) is composed of plural (n) SF periods (#1 to #n) divided in terms of time for tone expression. Each SF period includes a reset period (TR), a next address period (TA), and a next sustain period (TS). Each SF of field is weighted with the length (number of time of sustain discharge) of the sustain period (TS), and the tone of the pixels are expressed by the combination of lighting ON/OFF in each SF.

In the reset period (TR), all the cells of SF are set to an initial state, and operations of charge write and adjustment for the preparation for the next address period (TA) are carried out. In the next address period (TA), address operations to select the cells to be lit (ON)/not lit (OFF) from the cells of SF are carried out. In the next sustain period (TS), in the selected cells which are addressed in the address period (TA) just before, sustain discharge to the X electrode and the Y electrode (21 and 22) is carried out and display operations are performed.

<Tone Expression and SF Conversion Table>

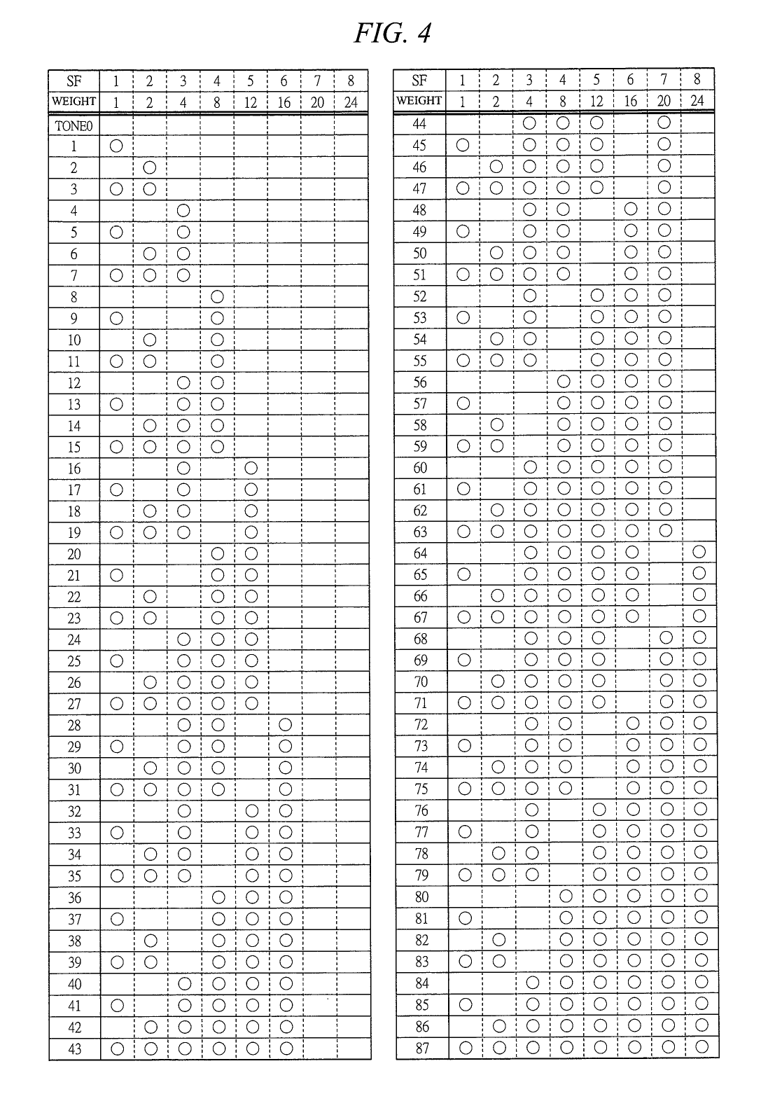

Next, FIG. 4 shows an example of the configuration of the SF conversion table (SF lighting pattern table). The SF conversion table determines the ON/OFF state of each SF of a field for each tone of the pixels in the display objective image. This example is an SF lighting pattern of the arithmetic arrangement method, and this is used in the present embodiment. A circle shows lighting (ON) and a blank shows non lighting (OFF). In the case of this table, the number of SFs of a field is eight from #1 to #8 and each of them is weighted as illustrated (1, 2, 4, 8, 12, 16, 20, and 24), and 87 (88 including 0) tones can be expressed by the combination of these ON/OFF. Further, digit changes in this table are present in plural portions, for example, carry of the maximum lighting SF from #7 to #8 in the change of tone from 63 to 64 and others.

<Multiple Tone Processing Unit (1)>

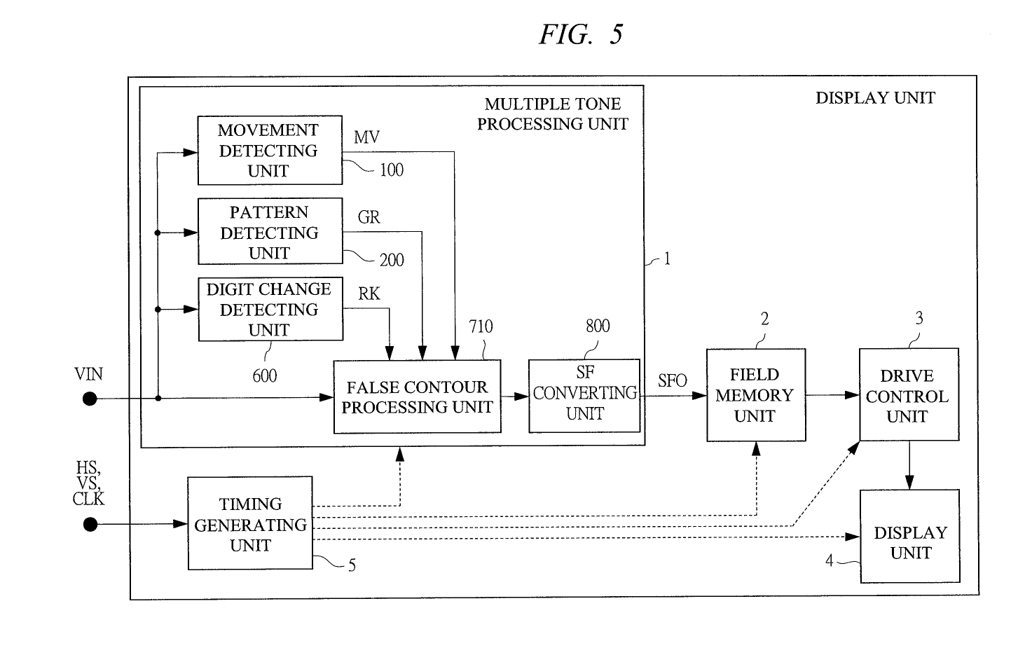

Next, the outline of the structure of the multiple tone processing unit 1 according to the first embodiment will be described with reference to FIG. 5. The multiple tone processing unit 1 includes a movement detecting unit 100, a pattern detecting unit (gradation detecting unit) 200, a digit change detecting unit 600, a false contour processing unit 710, and an SF converting unit 800.

The movement detecting unit 100 inputs an input image signal VIN, and detects and outputs the movement amount MV showing the size of movement of the portion moving in the video image. The pattern detecting unit 200 inputs VIN, and calculates the difference in pixel values between a concerned pixel and its adjacent pixel in the image to detect and output the edge amount GR. The digit change detecting unit 600 inputs VIN, and detects a carry or a borrow of SF of a specified SF conversion table between adjacent pixels in the image. When there is such a digit change, it outputs logic value “1” as a digit change signal RK, and when there is no digit change, it outputs logic value “0”.

The false contour processing unit 710 is a signal processing circuit, and it inputs VIN, MV, GR, and RK, and selects and executes a signal process for reducing the false contours on the basis of them, and then, it outputs the signal after the process.

The SF converting unit 800 inputs the output signal of the false contour processing unit 710, and outputs a signal (field and SF data) SFO to control ON/OFF of each SF of the field by the encoding (SF conversion) in accordance with a specified SF conversion table. In the SF converting unit 800, for example, an SF conversion table as shown in FIG. 4 is recorded.

As signal processes for reducing the false contours, the false contour processing unit 710 has, for example, a multiple tone process (first process) for prioritizing the number of tones in an area where false contours are not recognized, a modulation process (second process) for diffusing the false contours, and a multiple tone process (third process) for selecting and displaying SF where the false contours are hard to occur at a fewer number of tones than the first process, and it selects one from the first to third processes and executes it in accordance with the condition determinations of MV, GR, and RK. As the condition determination, for example, when a movement part has an MV of a specified value or more and RK of “1” (digit change is present), a signal process and the contents thereof are selected and executed based on the edge amount GR.

According to the first embodiment, since an appropriate signal process is selected especially in accordance with the edge amount GR, it is possible to reduce or prevent the false contours and others in accordance with various gradations when moving images are displayed, and thus, the image quality can be improved.

### Second Embodiment

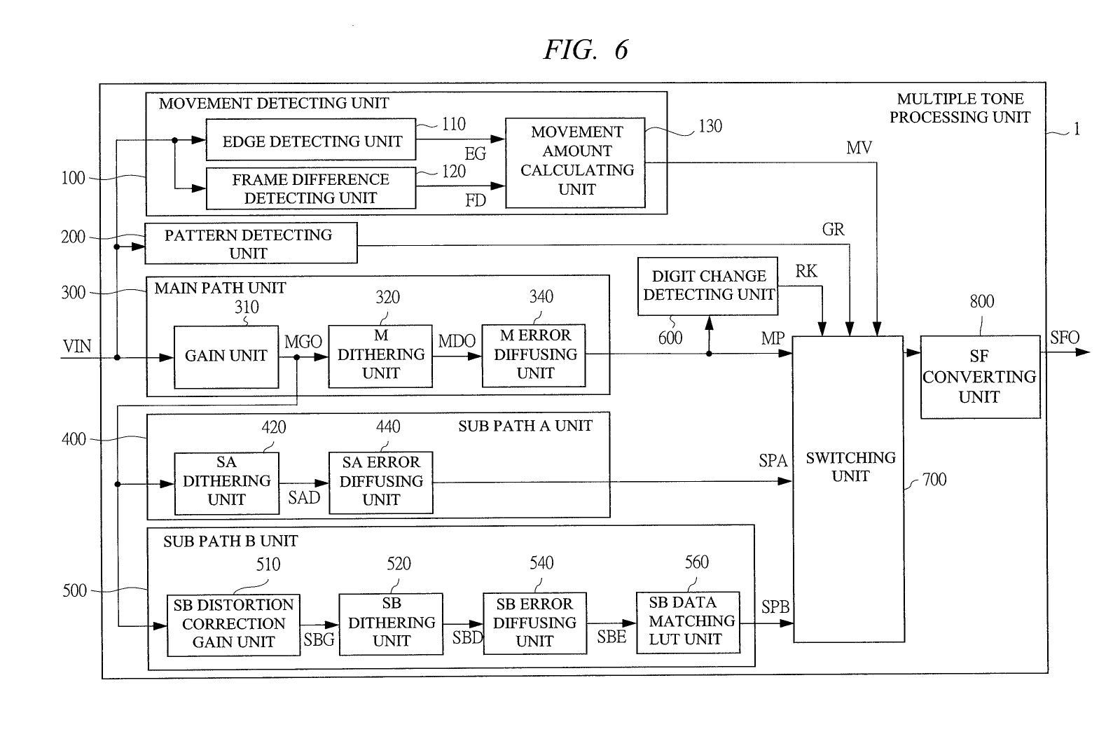

A second embodiment will be described below with reference to FIG. 6 to FIG. 32 and others. The feature of the second embodiment lies in that, in the multiple tone processing unit, paths for a plurality of processes for processing false contours are switched on the basis of detection of movement, gradation, and digit change of the input image signals.

<Multiple Tone Processing Unit (2)>

The outline of the structure of the multiple tone processing unit 1 according to the second embodiment will be described with reference to FIG. 6. The multiple tone processing unit 1 includes a movement detecting unit 100, a pattern detecting unit (gradation detecting unit) 200, a gain unit 310, a main path unit 300, a sub path A unit (first sub path unit) 400, a sub path B unit (second sub path unit) 500, a digit change detecting unit 600, a switching unit 700, and an SF converting unit 800.

The movement detecting unit 100 inputs an input image signal VIN, and detects and outputs the movement amount MV expressing the size of movement of the moving portion in video images. The pattern detecting unit 200 inputs VIN, and calculates the difference in pixel values between adjacent pixels and detects and outputs the edge amount GR as the amount expressing the size of inclination of the gradation.

The gain unit 310 inputs VIN, applies gain thereto, and then outputs the signal MGO of the number of tones of the SF conversion table stored in the SF converting unit 800. For example, when VIN is 10 bits and 1024 tones and the SF conversion table is 87 tones, the gain of 87/1024 is applied. In this case, since the 87 tones are 7 bits, 3 bits become a decimal number.

As the process of the main path, the main path unit 300 inputs MGO and outputs a signal MP after multiple tone process. The number of output tones of the signal MP is the same as the number of tones in the SF conversion table stored in the SF converting unit 800 described later. As the process of the first sub path, the sub path A unit 400 inputs MGO and outputs a signal SPA after modulation process. As the process of the second sub path, the sub path B unit 500 outputs a signal SPB of a fewer number of tones than the main path. In other words, the process of the sub path B unit 500 is a modulation process larger than the modulation process of the sub path A unit 400.

The digit change detecting unit 600 inputs the signal MP and detects a carry or a borrow of SF of the SF conversion table between adjacent pixels in image. When there is such a digit change, it outputs logic value “1” as digit change signal RK, and when there is no digit change, it outputs logic value The switching unit 700 inputs the MP, SPA, and SPB, as well as MV, GR, and RK, and it switches and outputs any one of MP, SPA, and SPB in plural paths on the basis of MV, GR, and RK. The SF converting unit 800 inputs the output signal of the switching unit 700, and generates and outputs a signal (field and SF data) SFO to control ON/OFF of each SF of the field in accordance with a specified SF conversion table stored in the SF converting unit 800.

<Data Conversion Transition>

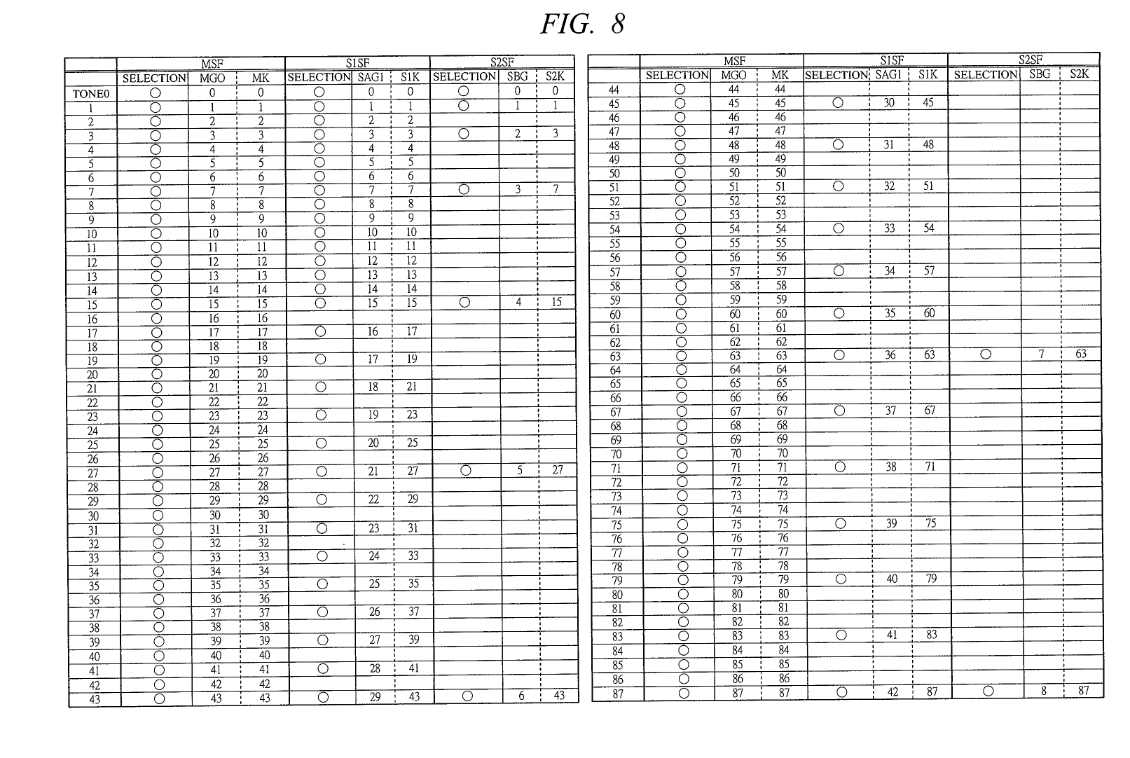

Next, FIG. 8 shows the transition of data conversion in the main path (output MP), the sub path A (output SPA), and the sub path B (output SPB). MSF is SF lighting pattern data group of the main path and the sub path A, S1SF is the transition of data conversion in the sub path A-2 described later, and S2SF is SF lighting pattern data group of the sub path B and is recorded in SF conversion table of the SF converting unit 800. The tones shown by circles in the columns of “selection” are the selected tones expressed by the path concerned. The tones are 87 including 0 in the main path and the sub path A, and 43 including 0 in the sub path A-2 described later, and 9 including 0 in the sub path B.

<Control (2-1)>

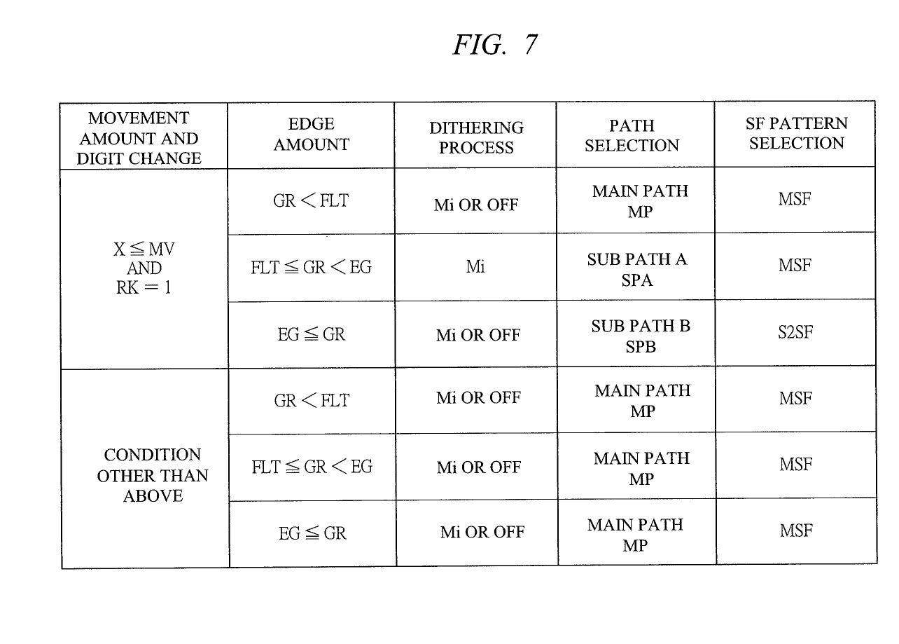

Next, FIG. 7 shows the control of the switching of processes in the multiple tone processing unit 1 according to the second embodiment. It shows process contents such as the dithering process (modulation process), the path selection of the switching unit 700, and SF lighting pattern data group (SF pattern selection) selected by the SF converting unit 800, in accordance with the detection state of the movement amount MV, the digit change signal RK, and the edge amount RG. The multiple tone processing unit 1 performs the switching in the following manner. Meanwhile, details of the dithering process and the like are described later.

(1) When a movement amount MV in a display objective image is a specified value X or more and an edge amount GR is smaller than a specified value FLT in the pixel where a carry is detected (RK=1), that is, in the case of a flat portion, modulation process with a modulation amount Mi or OFF (no process) may be performed in the dithering process, and the main path (MP output) is selected in the path selection, and also, images are expressed by the use of MSF in the SF pattern selection.

(2) Also, when the edge amount GR is FLT or more and less than EG in the pixel similar to that described above, that is, in the case of a gradation of a certain degree, modulation process with Mi is performed in the dithering process, and the sub path A is selected in the path selection, and images are expressed by MSF in the SF pattern selection.

(3) Further, when the edge amount GR is EG or more in the pixel similar to that described above, that is, in the case of an edge portion, modulation process with a modulation amount Mi or OFF may be performed in the dithering process, and the sub path B is selected in the path selection, and images are expressed by the use of S2SF in the SF pattern selection.

(4) Furthermore, when the detection results of the movement amount and the carry are other than the above, any of the modulation with Mi and OFF can be performed in the dithering process, and the main path is selected in the path selection, and images are expressed by the use of MSF in the SF pattern selection.

<Main Path>

Next, the structure of the main path unit 300 of the multiple tone processing unit 1 will be described with reference to FIG. 6. The main path unit 300 includes an M dithering unit 320 and an M error diffusing unit 340.

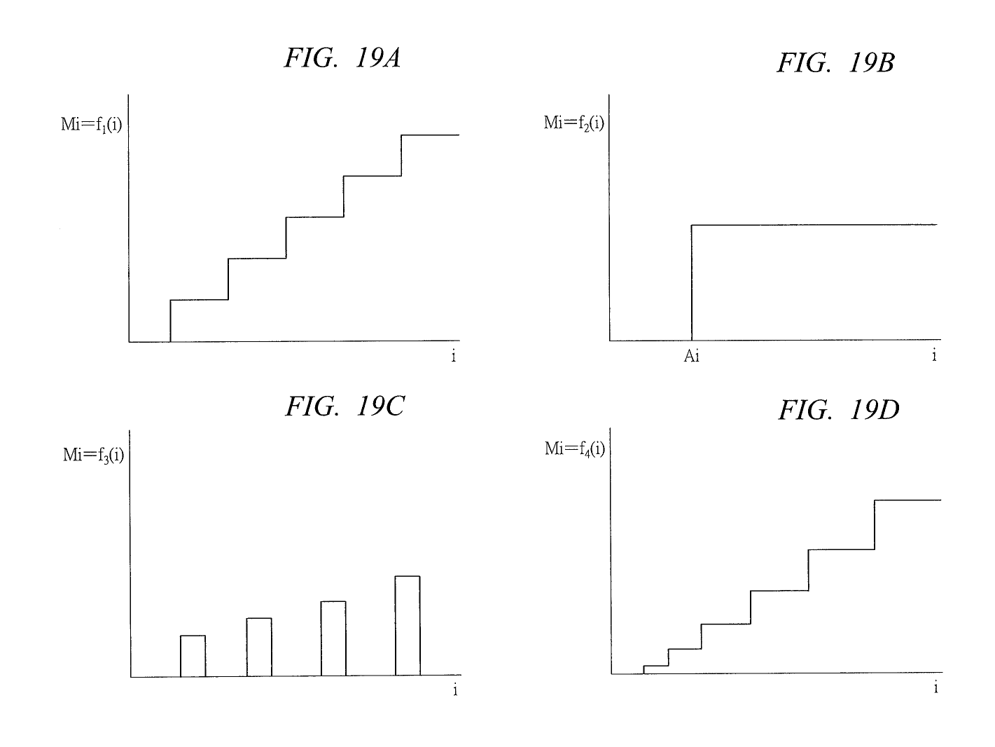

The M dithering unit 320 inputs the signal MGO of the output of the gain unit 310 and outputs a signal MDO obtained by modulating input signal with a specified modulation amount M. The modulation amount M has a relation to the input value (MGO) of the M dithering unit 320 as shown in FIG. 19. The modulation amount in the main path unit 300 may be 0.

The M error diffusing unit 340 inputs the output signal MDO of the M dithering unit 320 and performs a diffusion process so as to spatially express decimal number of the gain unit 310, and then outputs a signal MP. The number of tones of MP is 87 which is equal to the number of tones to be inputted to the SF converting unit 800, and the number of bits is 7. The output value of MP corresponds to the column MK in FIG. 8.

<Sub Path A-1>

Next, the structure of the sub path A unit 400 of the multiple tone processing unit 1 will be described with reference to FIG. 6. The sub path A unit 400 includes an SA dithering unit 420 and an SA error diffusing unit 440.

The input of the sub path A unit 400 is MGO and the output thereof is SPA. The circuit of the SA gain unit 401 is the same as the gain unit 310 of the main path unit 300, and the input thereof is VIN and the output thereof is SGO, and the gain thereof is the same as that of the gain unit 310. The circuit of the SA dithering unit 420 is the same as the M dithering unit 320 of the main path unit 300, and the input thereof is MGO, and it outputs a signal SAD obtained by the modulation process with the modulation amount M. The circuit of the SA error diffusing unit 440 is the same as the M error diffusing unit 340 of the main path unit 300, and the input thereof is SAD, and it outputs the signal SPA. The output value of SPA corresponds to the column MK in FIG. 8. In the SA error diffusing unit 440, the number of tones of the output SPA may be made smaller than that of the main path unit 300. In this case, modulation by error diffusion is to be used.

<Sub Path A-2>

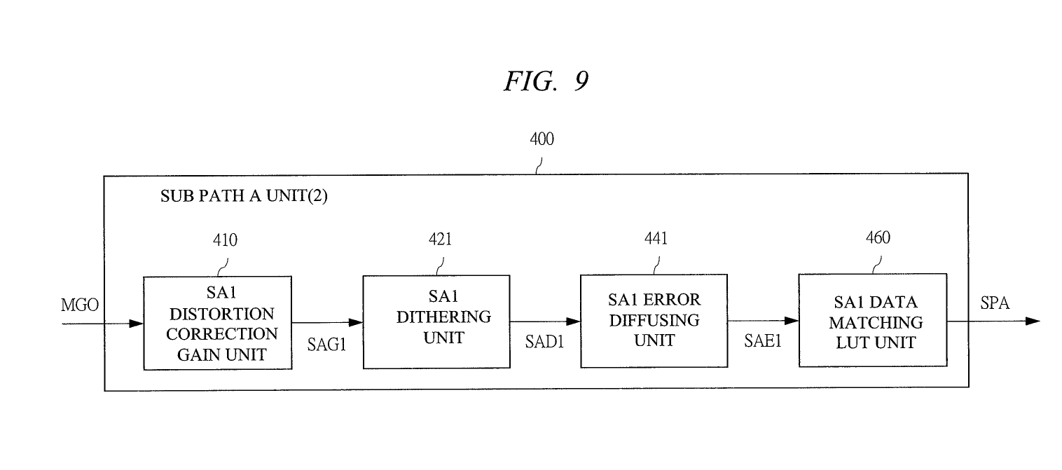

Next, a modified example (second structure) of the sub path A unit 400 of the multiple tone processing unit 1 according to the second embodiment will be described with reference to FIG. 9. This sub path A unit (2) 400 includes an SA1 distortion correction gain unit 410, an SA1 dithering unit 421, an SA1 error diffusing unit 441, and an SA1 data matching LUT unit 460.

The SA1 distortion correction gain unit 410 inputs MGO, applies a specified gain thereto, and then outputs an output signal SAG1. In the data transition between paths, the selected tones that the sub path A unit 400 can express are shown by the tones with circles of “selection” in S1SF in FIG. 8. The selected tone is 42. In consideration of characteristics of human eyes, tone step is fine at the low tone side, and as the tone becomes larger, the step interval is made larger. The tone not selected is expressed by using nearest tones above and below it. The output SAG1 of the SA1 distortion correction gain unit 410 is shown in the column “SAG1”.

FIG. 10 shows characteristics (gain characteristics) of the input (MGO) and the output (SAG1) of the SA1 distortion correction gain unit 410 in the modified example (second structure) of the sub path A unit 400. The output is one step. MGO is a value from 0 to 87 and SAG1 is a value from 0 to 42.

The SA1 dithering unit 421 inputs the outputs SAG1 of the SA1 distortion correction gain unit 410 and outputs a signal SAD1 obtained by the modulation process with a specified dithering amount. This circuit may be the same as the M dithering unit 320.

The SA1 error diffusing unit 441 inputs the output SAD1 of the SA1 dithering unit 421, and the output thereof is SAE1. The number of tones of the output SAE1 of the SA1 error diffusing unit 441 is 42, and it is 6 bits. This means that modulation becomes stronger than the main path unit 300.

The SA1 data matching LUT unit 460 inputs the output SAE1 of the SA1 error diffusing unit 441 and outputs a signal SPA. The number of tones of the input and that of the output are equal to each other. When the input value is the column of “SAG1” in FIG. 8, the output value is converted into the value of column of “S1K”. The SA1 data matching LUT unit 460 performs data matching process of input and output on the basis of a LUT (lookup table) as shown in FIG. 8.

In FIG. 8, in the sub path A2, the output SAG1 of the SA1 distortion correction gain unit 410 is controlled to the value from 0 to 42, and the output SPA of the SA1 data matching LUT unit 460 is returned to the input value. Value interval is not continuous but skipped. Also in the sub path B, similar control process is performed in the same manner.

<Sub Path B>

Next, the sub path B unit 500 of the multiple tone processing unit 1 will be described with reference to FIG. 6. This sub path B unit 500 includes an SB distortion correction gain unit 510, an SB dithering unit 520, an SB error diffusing unit 540, and an SB data matching LUT unit 560.

The SB distortion correction gain unit 510 inputs MGO, applies a specified gain thereto, and then outputs an output signal SBG. The function thereof is the same as the SA1 distortion correction gain unit 410. In the data transition in the sub path B unit 500, the selected tones that the sub path B unit 500 can express are shown by the tones with circles of “selection” in S2SF in FIG. 8. The selected tone is 9 including 0. The output SBG of the SB distortion correction gain unit 510 is shown in the column of “SBG”.

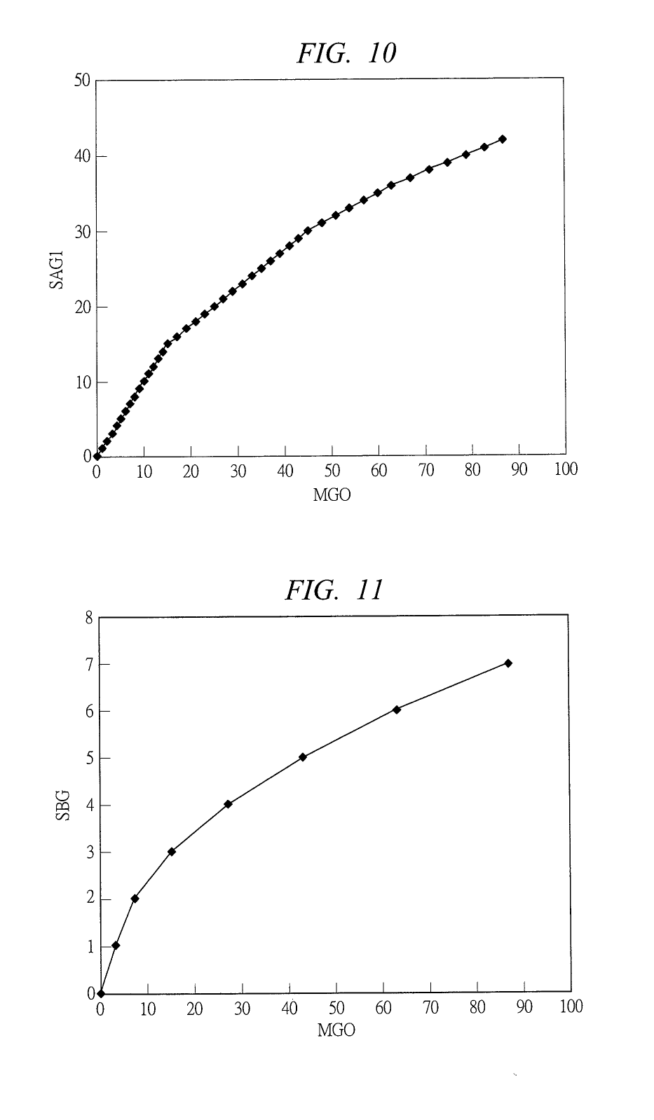

FIG. 11 shows characteristics of the input (MGO) and the output (SBG) of the SB distortion correction gain unit 510 in the sub path B unit 500.

The SB dithering unit 520 inputs the outputs SBG of the SB distortion correction gain unit 510 and outputs a signal SBD obtained by the modulation by the dithering process. The circuit thereof may be the same as the M dithering unit 320, but the dithering tone setting and the dithering setting coefficient are different. The dithering setting coefficient may be 0.

The SB error diffusing unit 540 inputs the output SBD of the SB dithering unit 520 and performs an error diffusing process to output a 4-bit signal SBE with the number of tones of 9.

The SB data matching LUT unit 560 inputs the output SBE of the SB error diffusing unit 540 and outputs a signal SPB. The number of tones of the input and that of the output are equal to each other. When the input value is the column of “SBG” of the sub path B unit 500 in FIG. 8, the output value is converted into the value of column of “S2K”.

<Movement Detecting Unit>

Next, the structure of the movement detecting unit 100 of the multiple tone processing unit 1 will be described with reference to FIG. 6. The movement detecting unit 100 includes an edge detecting unit 110, a frame difference detecting unit 120, and a movement amount calculating unit 130.

The edge detecting unit 110 inputs VIN and outputs an edge amount EG which is the difference in the pixel values between the concerned pixel and its adjacent pixel in an image. The frame difference detecting unit 120 inputs VIN and outputs a frame difference amount FD which is the difference between the pixel value of the concerned pixel and the pixel value at the same position before one field. The movement amount calculating unit 130 inputs EG and FD and outputs the movement amount MV of an image by calculation. As the calculation method thereof, for example, a gradient method where FD is divided by EG is employed.

<Pattern Detecting Unit>

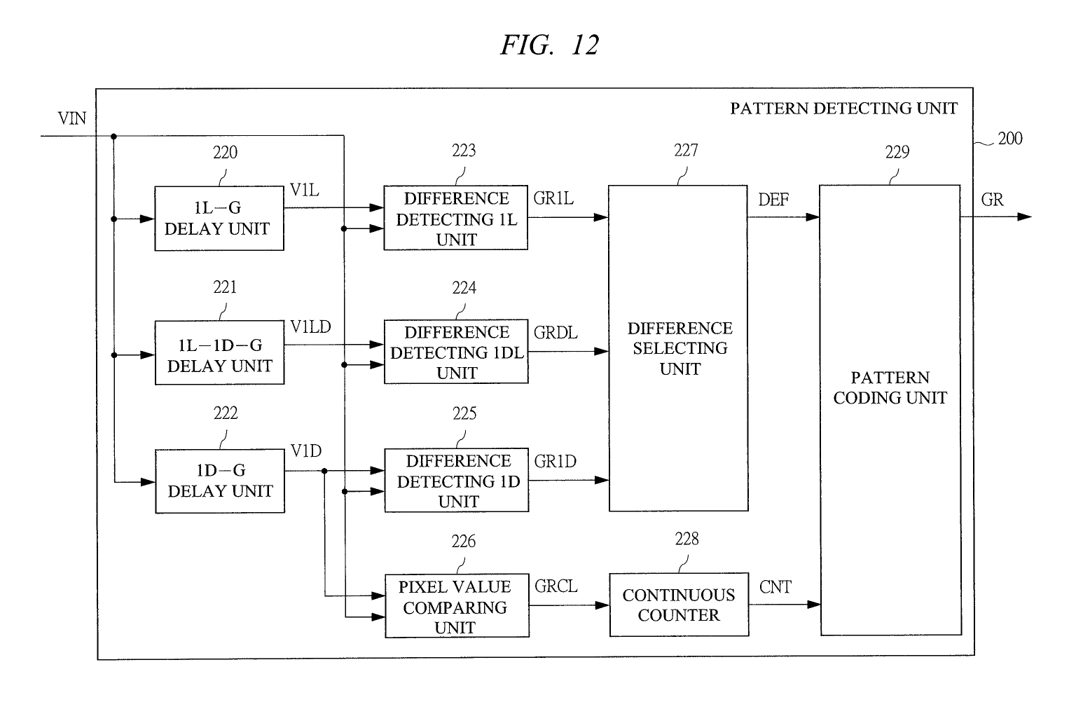

Next, FIG. 12 shows the structure of the pattern detecting unit 200 of the multiple tone processing unit 1. The pattern detecting unit 200 includes memories and delay units such as a 1L-G delay unit 220 and the like, difference detecting units such as a difference detecting 1L unit 223 and the like, a pixel value comparing unit 226, a difference selecting unit 227, a continuous counter 228, and a pattern coding unit 229.

The 1L-G delay unit 220 inputs VIN and outputs V1L (delay data for one line). The 1L-1D-G (pixel) delay unit 221 inputs VIN and outputs V1LD (delay data for one line-one pixel). The 1D-G delay unit 222 inputs VIN and outputs V1D (delay data for one pixel). The difference detecting 1L unit 223 inputs VIN and V1L and detects the difference value between VIN and V1L to output it as GR1L. The difference detecting 1DL unit 224 inputs VIN and V1LD and detects the difference value between VIN and V1LD to output it as GRDL. The difference detecting 1DL unit 225 inputs VIN and V1D and detects the difference value between VIN and V1D output it as GR1D. The difference selecting unit 227 inputs GR1L, GRDL and GR1D and selects the large value from them to output it as DEF. The pixel value comparing unit 226 inputs VIN and V1D and compares the values of VIN and V1D, and outputs a signal GRCL that becomes “0” when the values are equal and “1” when they are different. The continuous counter 228 inputs GRCL, and when GRCL is “0”, it counts up by one in unit of pixel, and when GRCL is “1”, it latches the counter value and outputs it as an output CNT, and then sets the counter value to “0”. The pattern coding unit 229 inputs DEF and CNT, and when the value of DEF is “0”, it selects the value of CNT, and when the value of DEF is not “0”, it selects the value of DEF, and then outputs it as the edge amount GR.

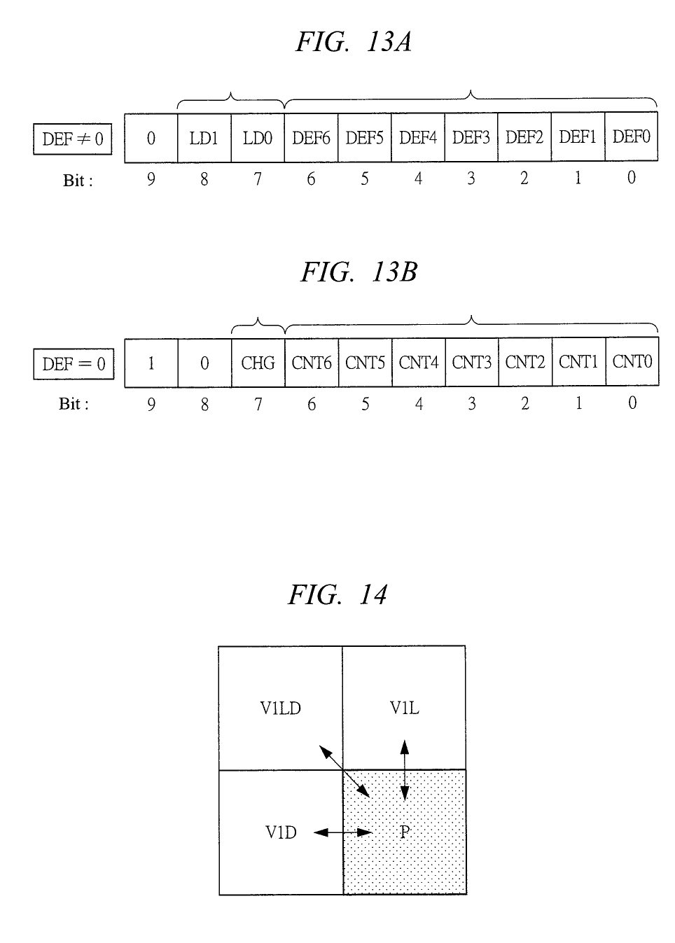

FIG. 13 shows a bitmap of GR of the output of the pattern coding unit 229 in the pattern detecting unit 200. In the case of DEF#0 in FIG. 13A, lower 7 bits are the values of DEF. Bits 7 and 8 (LD0 and LD1) are signals showing the positions of adjacent pixels with a large difference value (maximum value direction flag). Bit 9 is “0”. When bits 7 and 8 are “00”, the upper adjacent pixel is selected, and when they are “01”, the left upper adjacent pixel is selected, and when they are “10”, the left adjacent pixel is selected. In the case of DEF=0 in FIG. 13B, the lower 7 bites are the values of CNT. Bit 7 is the signal of GRCL (tone change flag). Bit 8 is “0”, and bit 9 is “1”. When the bit 7 is “0”, it shows there is no change, and when it is “1”, it shows there is a change.

FIG. 14 shows the detection method of the edge amount GR in the pattern detecting unit 200. A gray area denoted by P is the concerned pixel. In the detection of the edge amount GR, the differences between the concerned pixel (P) and its three adjacent pixels of the upper pixel (V1L), the left upper pixel (V1LD), and the left pixel (V1D) are calculated, respectively.

<Digit Change Detecting Unit>

Next, FIG. 15 shows the structure of the digit change detecting unit 600 of the multiple tone processing unit 1. The digit change detecting unit 600 includes digit value setting units (611 to 614), digit comparing units (615 to 618), a digit coding unit 619, delay units such as a 1L-R delay unit 620 and the like, a coding difference comparing unit 623, a delay unit 624, and an OR circuit 625.

In the digit value setting units (1) to (N) 611 to 614, a signal level corresponding to the tone of carry is set. In the digit comparing circuit units (1) to (N) 615 to 618, an input signal MP (or MGO) and digit value setting are compared, and signals RKC1 to RKCN as the comparison results are outputted. RKC1 to RKCN output “1” when the input MP (or MGO) is large and outputs “0” when it is small.

The digit coding unit 619 inputs RKC1 to RKCN and outputs a signal RKCD converted into the digit of SF after the conversion by the SF conversion table in FIG. 4. The 1L-R delay unit 620 inputs RKCD and outputs a signal RKCD1L (1L data) delayed by one line. The 1D-R delay unit 621 inputs RKCD and outputs a signal RKCD1D (1D delay data) delayed by one pixel. The 1L-1D-R delay unit 622 inputs RKCD and outputs RKCDLD (1L-1D delay data). The coding difference comparing unit 623 inputs RKCD, RKCD1L, RKCD1D, and RKCDLD and compares differences between RKCD as the concerned pixel and the respective adjacent pixels (RKCD1L as the upper pixel by one line, RKCD1D as the left adjacent pixel, and RKCDLD as the left upper pixel), and if there is difference in any of them, it detects that there is a digit change, and if there is no difference, it detects that there is no digit change. The delay unit 624 delays the output of the coding difference comparing unit 623. The OR circuit 625 calculates the logic OR of the output of the coding difference comparing unit 623 and the output of the delay unit 624 and detects the carry pixel and its peripheral pixels, and then outputs a digit change signal RK which is the detection result.

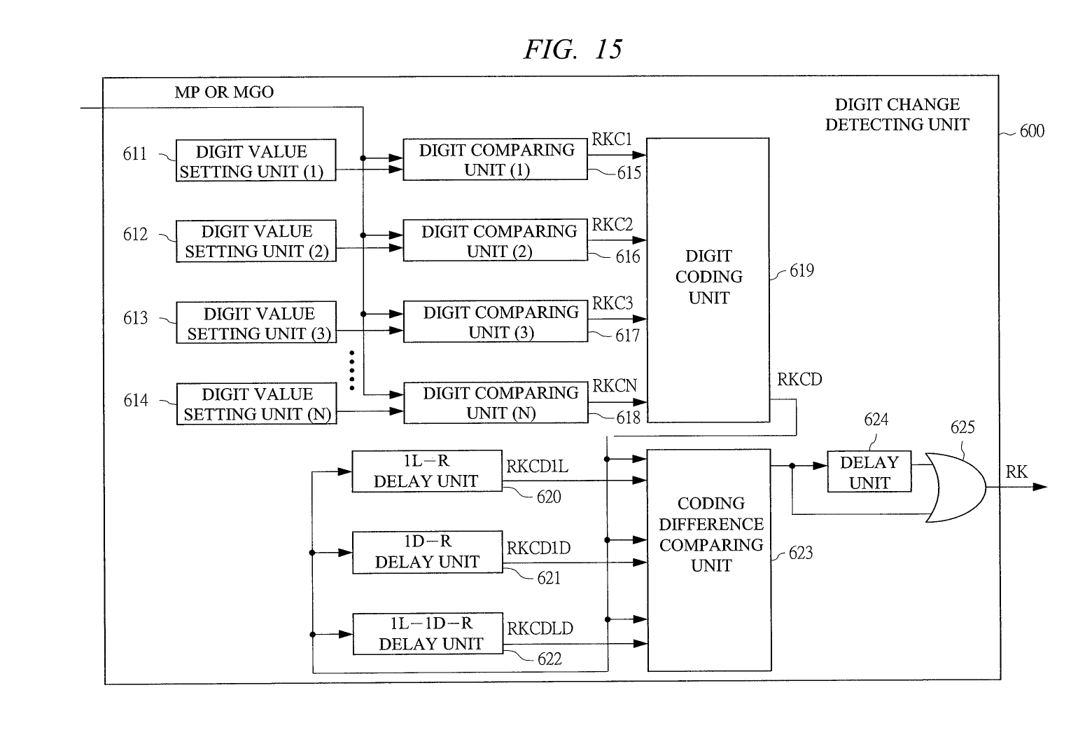

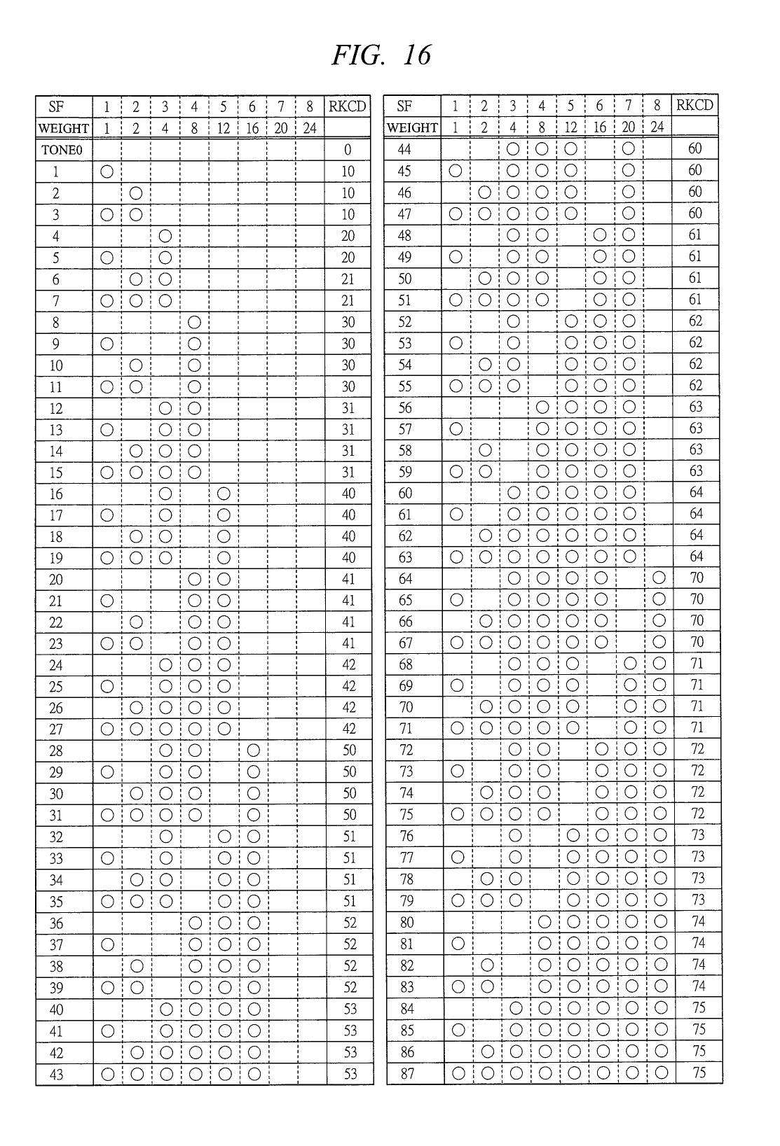

FIG. 16 shows the configuration of the coding of the digit coding unit 619 in the digit change detecting unit 600. The value of tens digit in the column of “RKCD” shows the digit number of SF lighting pattern.

<M Dithering Unit>

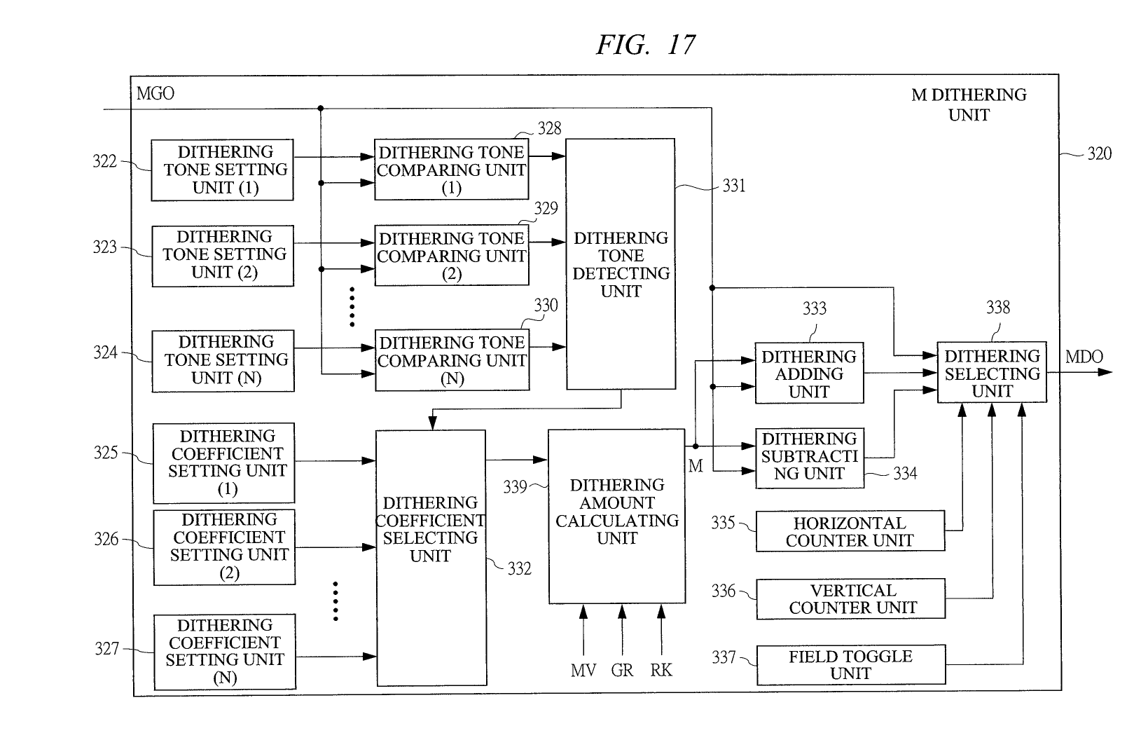

Next, FIG. 17 shows an example of the structure of the dithering unit in the embodiments (2 to 4). As the second embodiment, the structure of the M dithering unit 320 in the main path unit 300 is shown. Among these, the dithering amount calculating unit 339 is not provided in the second embodiment, and it is provided in the third and fourth embodiments. The M dithering unit 320 includes dithering tone setting units (322 to 324), dithering coefficient setting units (325 to 327), dithering tone comparing units (328 to 330), a dithering tone detecting unit 331, a dithering coefficient selecting unit 332, a dithering adding unit 333, a dithering selecting unit 338, a dithering subtracting unit 334, a horizontal counter unit 335, a vertical counter unit 336, and a field toggle unit 337. The M dithering unit 320 outputs a modulation amount M from the dithering coefficient selecting unit 332. The dithering process itself is a well known art.

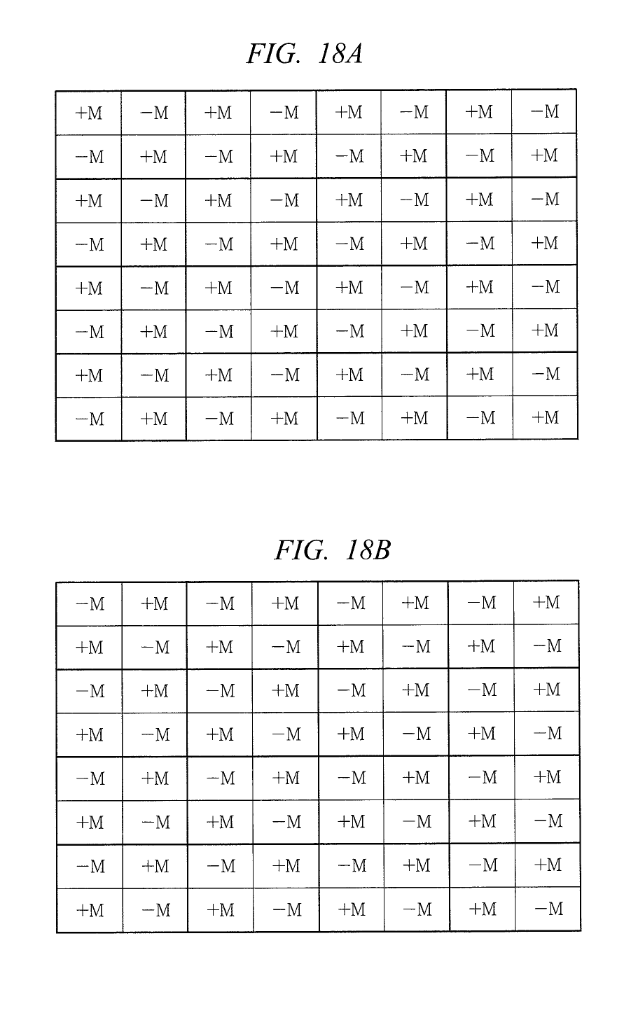

FIG. 18 shows the modulation process by dithering process in the M dithering unit 320 and the like. Two pixels in horizontal and vertical directions, four pixels in total are defined as one block, and such blocks are arranged in one surface. M is the dithering amount (modulation amount). FIG. 18A shows the process of the n th field and FIG. 18B is the process of the n+1 th field. In the n th field of FIG. 18A and the n+1 th field of FIG. 18B, signs + and − in M are reversed.

FIG. 19 shows the relation of dithering amount (Mi) to the input tone (i) in the M dithering unit 320. In general, as it gets brighter, a human cannot recognize differences in brightness. In FIG. 19A, the dithering amount Mi is gradually increased with the increase of the input value i. In FIG. 19B, a specified dithering amount Mi is set at a specified input value Ai or more. In FIG. 19C, the dithering amount Mi is set to specified input values i, more concretely, to the input values i corresponding to the tones where false contours occur, and as the input value i becomes larger, the dithering amount Mi is also made larger. In FIG. 19D, similar to FIG. 19A, the dithering amount Mi is gradually increased with the increase of the input value i, but the change amount of the dithering amount Mi is larger. In any of them, the effect of diffusion can be obtained. Also, the dithering amount Mi is expressed by the function of the input value i: f(i).

<M Error Diffusing Unit>

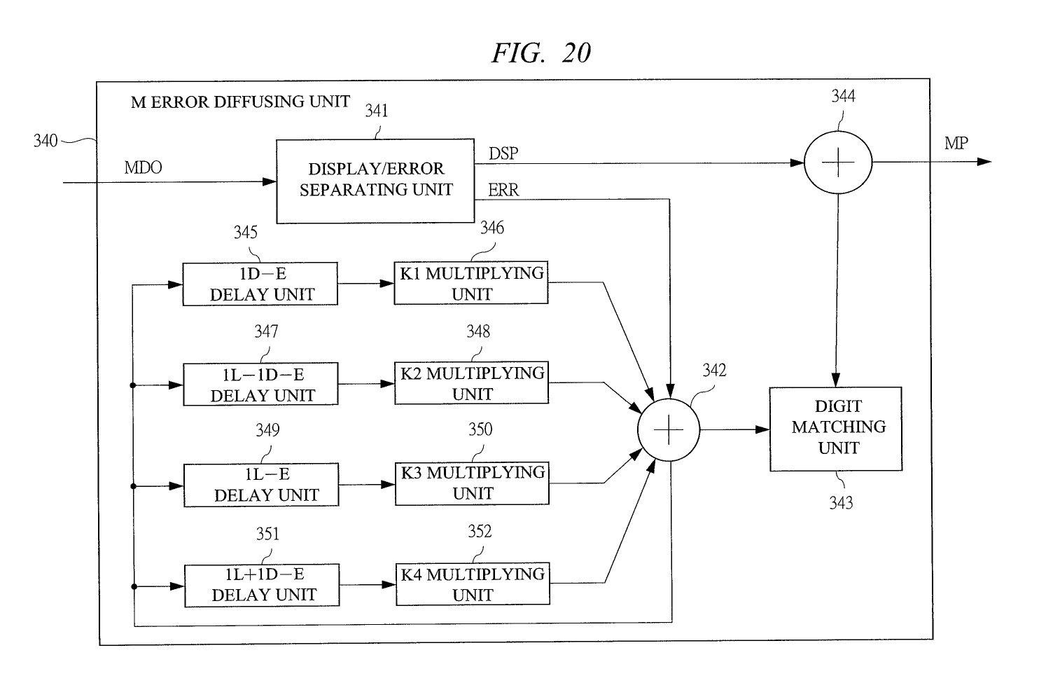

Next, FIG. 20 shows the structure of the M error diffusing unit 340 in the main path 300. In the M error diffusing unit 340, information of 3-bit decimal point outputted by the gain unit 310 is expressed spatially. The M error diffusing unit 340 includes a display/error separating unit 341, adding units 342 and 344, a digit matching unit 343, memories and delay units (1D-E delay unit 345 and the like), and multiplying units (K1 multiplying unit 346 and the like). The error diffusing process itself is a well known art.

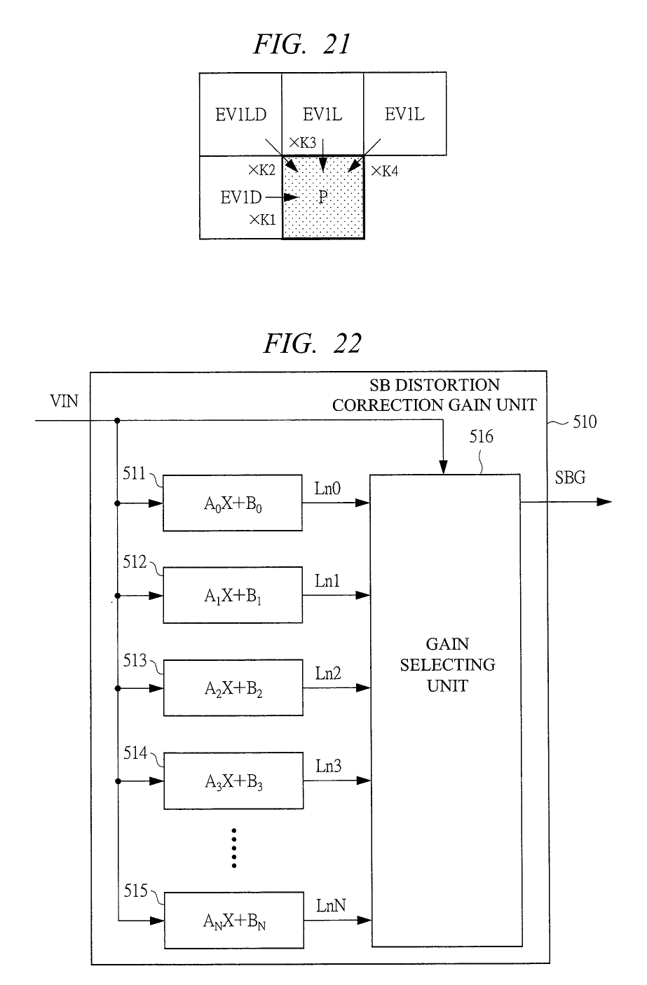

FIG. 21 shows the diffusing method of the M error diffusing unit 340. A gray area denoted by P is the concerned pixel. In the error diffusion process, the error value of the left adjacent pixel (EV1D) of the concerned pixel (P) is multiplied by K1, the error value of the left upper adjacent pixel (EV1LD) thereof is multiplied by K2, and the error value of the upper adjacent pixel (EV1L) thereof is multiplied by K3, and the error value of the right upper adjacent pixel (EV1L) thereof is multiplied by K4, and they are added with the error value ERR of the attention pixel (P).

<Distortion Correction Gain Unit>

Next, FIG. 22 shows the structure of the distortion correction gain unit in the respective embodiments. As the second embodiment, the structure of the SB distortion correction gain unit 510 is shown. The SB distortion correction gain unit 510 includes calculating units (511 to 515) and a gain selecting unit 516. The gain characteristics in the distortion correction gain unit are shown in FIG. 10 and FIG. 11.

An A0X+B0 calculating unit 511 inputs VIN and calculates A0×VIN+B0, and then outputs Ln0. Similarly, an A1X+B1 calculating unit 512 inputs VIN and calculates A1×VIN+B1, and then outputs Ln1. In the same manner, N+1 calculations in total are performed and Ln0 to LnN are outputted. The gain selecting unit 516 inputs Ln0 to LnN and VIN and outputs SBG. The SBG is the one value selected from Ln0 to LnN.

<SA Dithering Unit—Effect>

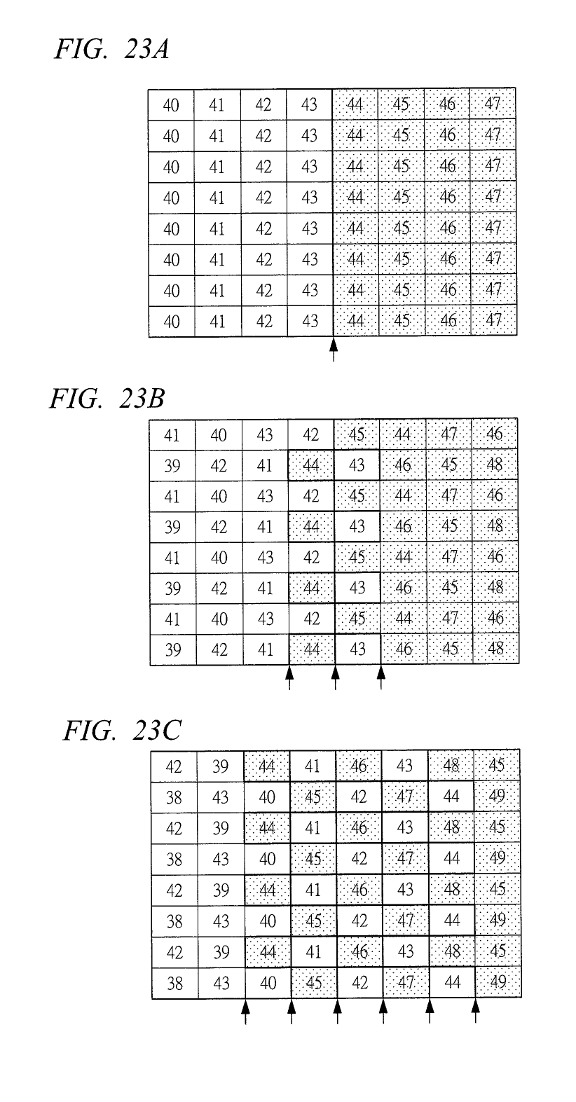

Next, FIG. 23 shows an effect (part 1) of the dithering process in the SA dithering unit 420 of the sub path A unit 400 according to the second embodiment. FIG. 23A is an original image inputted to the dithering unit, which shows the case of a moderate gradation image (lamp signal) where the tone level increases by one tone (step) by one pixel in the right direction. Note that the SF converting unit 800 performs the SF conversion by the SF conversion table in FIG. 4. When this image portion moves to the left or the right, there is a possibility that a linear false contour in one column may be recognized between the fourth pixel (tone 43) and the fifth pixel (tone 44) from the left. FIG. 23B shows the case where the original image of FIG. 23A is modulated by the modulation amount (dithering amount) M=1. In this case, false contours to be recognized are regularly dispersed between the third pixel and the fourth pixel from the left, between the fourth pixel and the fifth pixel, and between the fifth pixel and the sixth pixel, and the false contours are not in a linear form different from that in FIG. 23A. The false contours are dispersed effectively. FIG. 23C shows the case where the original image of FIG. 23A is modulated by the modulation amount M=2. The false contours to be recognized are regularly dispersed in six columns between the second pixel and the eighth pixel from the left, and the false contours are not in a linear form different from that in FIG. 23A. However, the false contours (noises) are recognized in hatched shape (zigzag shape).

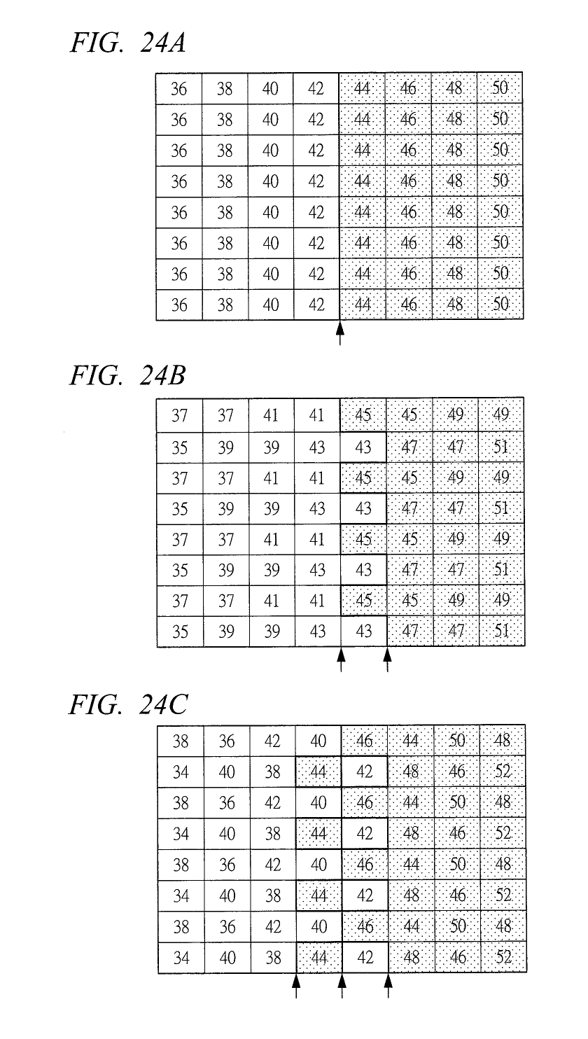

Also, FIG. 24 shows another effect (part 2) of the dithering process in the SA dithering unit 420. FIG. 24A is an original image inputted to the dithering unit, which shows the case of a gradation image (lamp signal) where the tone level increases by two tones by one pixel in the right direction. When this image portion moves to the left or the right, there is a possibility that a linear false contour in one column may be recognized between the fourth pixel (tone 42) and the fifth pixel (tone 44) from the left. FIG. 24B shows the case where the original image of FIG. 24A is modulated by the modulation amount (dithering amount) M=1. In this case, false contours to be recognized are regularly dispersed in two columns between the fourth pixel and the fifth pixel from the left and between the fifth pixel and the sixth pixel, and the false contours are not in a linear form different from that in FIG. 24A. However, this dispersion is not so wide as that in FIG. 23B. FIG. 24C shows the case where the original image of FIG. 24A is modulated by the modulation amount M=2. The false contours to be recognized are regularly dispersed in three columns between the third pixel and the fourth pixel from the left, between the fourth pixel and the fifth pixel, and between the fifth pixel and the sixth pixel, and the false contours are not in a linear form different from that in FIG. 24A. This is the same effect as that in FIG. 23B.

As described above, if the modulation amount (M) of the dithering process is not increased as the size of inclination of gradation, that is, the edge amount GR becomes larger, the false contours are not diffused and there is no effect. However, since the modulation amount (M) of the dithering process is too large in the portion where the inclination of gradation is large, the zigzag patterns as shown in FIG. 23C are clearly recognized. Therefore, the application of the dithering process is not preferable. In the present embodiment, in consideration of the above, appropriate modulation amount (M) of the dithering process is selected in accordance with the gradation (edge amount GR). More specifically, the modulation amount (M) is selected so that the process result in the SA dithering unit 420 becomes as shown in FIG. 23B and FIG. 24C.

<SA Error Diffusing Unit—Effect>

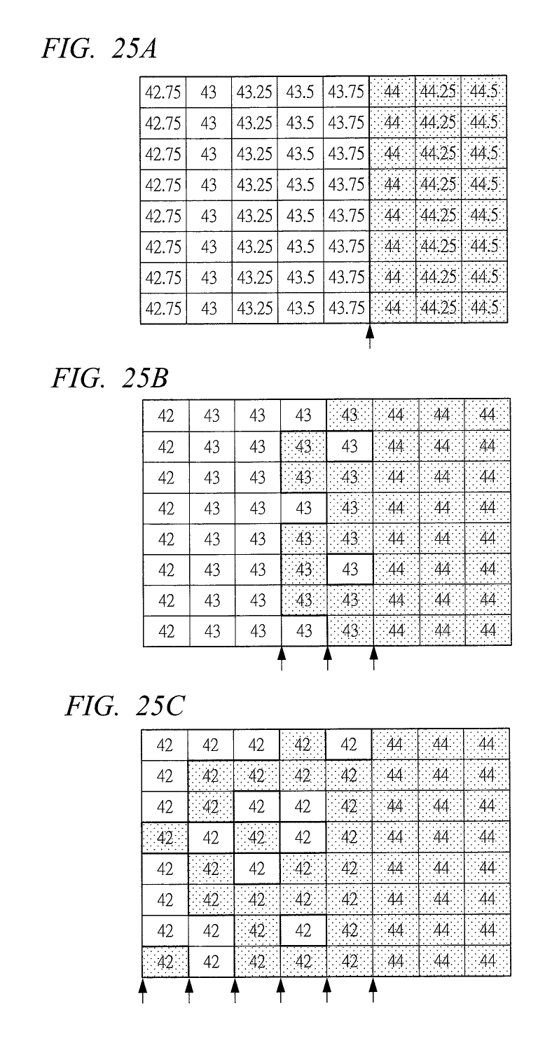

Next, FIG. 25 shows an effect (part 1) of the error diffusion process in the SA error diffusing unit 440 of the sub path A unit 400. FIG. 25A is an original image inputted to the SA error diffusing unit 440, which shows the case of an image of extremely moderate gradation where the signal value level increases by 0.25 step by one pixel in the right direction. When this image portion moves to the left or the right, there is a possibility that a linear false contour in one column may be recognized between the fifth pixel (tone 43.75) and the sixth pixel (tone 44) from the left. FIG. 25B shows the case where the output of error diffusion to the original image of FIG. 25A is processed by 7 bits. In this case, false contours to be recognized are irregularly dispersed in three columns between the third pixel and the fourth pixel from the left, between the fourth pixel and the fifth pixel, and between the fifth pixel and the sixth pixel, and the false contours are not in a linear form different from that in FIG. 25A. FIG. 25C shows the case where the output of error diffusion to the original image of FIG. 25A is processed by 6 bits. In this case, false contours to be recognized are irregularly dispersed in six columns between the first pixel and the sixth pixel from the left, and the false contours are not in a linear form different from that in FIG. 25A. The false contours are dispersed more widely than those in FIG. 25B.

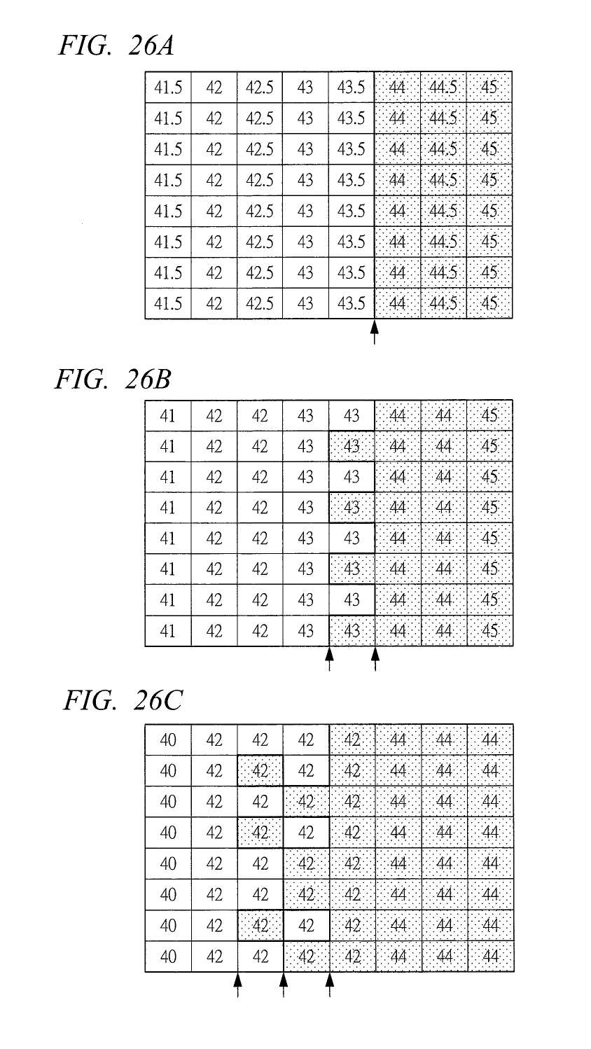

Further, FIG. 26 shows another effect (part 2) of the error diffusion process in the SA error diffusing unit 440 of the sub path A unit 400. FIG. 26A is an original image, which shows the case of an image of a moderate gradation where the signal value level increases by 0.5 step by one pixel in the right direction. When this image portion moves to the left or the right, there is a possibility that a linear false contour in one column may be recognized between the fifth pixel (tone 43.5) and the sixth pixel (tone 44) from the left. FIG. 26B shows the case where the output of error diffusion to the original image of FIG. 26A is processed by 7 bits. In this case, false contours to be recognized are dispersed in two columns between the fourth pixel and the fifth pixel from the left and between the fifth pixel and the sixth pixel and the false contours are not in a linear form different from that in FIG. 26A. FIG. 26C shows the case where the output of error diffusion to the original image of FIG. 26A is processed by 6 bits. In this case, false contours to be recognized are irregularly dispersed in three columns between the second pixel and the third pixel from the left, between the third pixel and the fourth pixel, and between the fourth pixel and the fifth pixel, and the false contours are not in a linear form. The false contours are dispersed more widely than those in FIG. 26B, and dispersed equally to those in FIG. 25B.

As described above, the error diffusing process has an effect of diffusion when gradation is extremely small. However, when gradation becomes large, although false contours are diffused by reducing the number of output bits of error diffusion, the number of tones becomes small. Since dynamic vision is poor in moving images, the output tone for error diffusion can be reduced. However, in still images, it is not preferable to reduce the number of output tones of error diffusion. In the present embodiment, in consideration of the fact above, appropriate number of output bits is selected in accordance with gradation (edge amount). In concrete, it is selected so that the process result in the SA error diffusing unit 440 becomes as shown in FIG. 25B and FIG. 26C.

<SB—Effect>

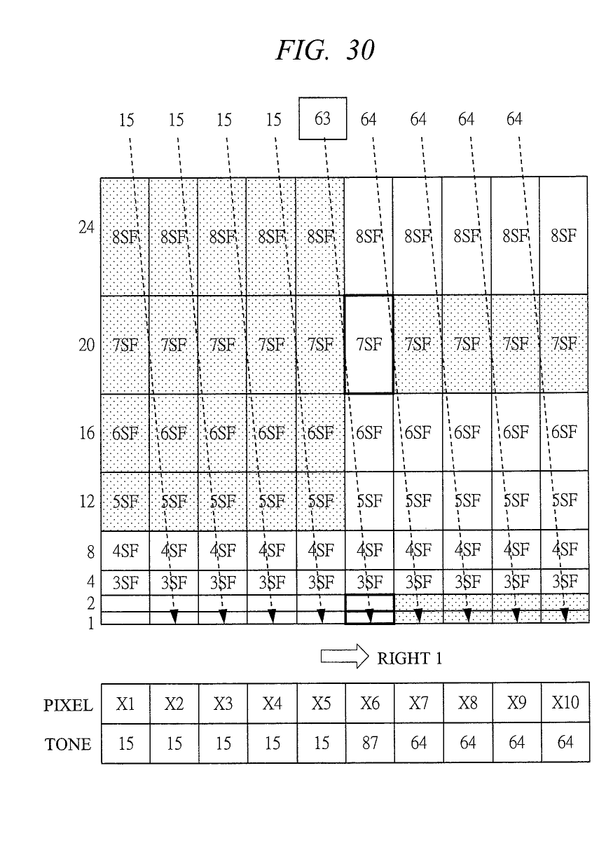

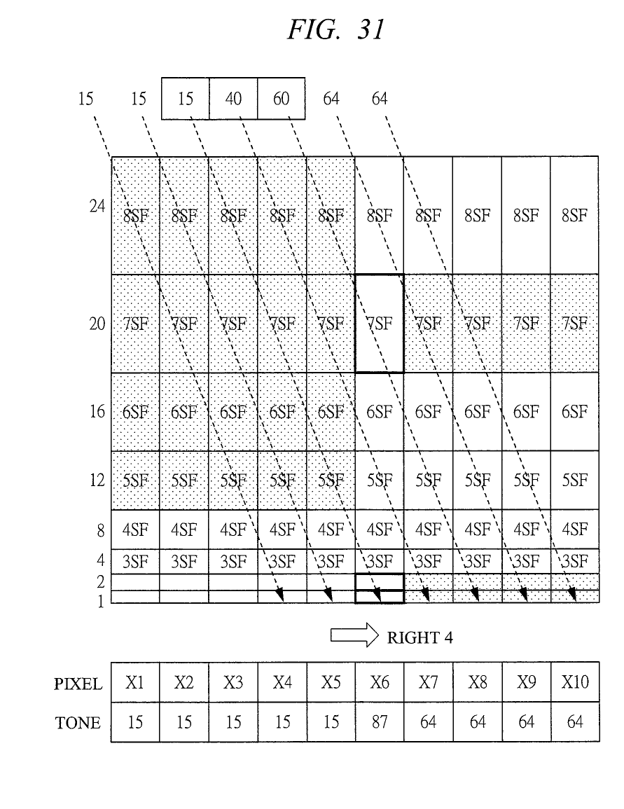

Next, FIG. 30 and FIG. 31 show the effect of reduction of false contours by the process of the sub path B unit 500 (second sub path) in the second embodiment and others. The effect of the process of the second sub path to images where false contours as shown in FIG. 27 to FIG. 29 occur is shown.

FIG. 30 shows the case where the image area moves by one pixel in one field in the right direction in the same manner as that in FIG. 28. By selecting the process of the sub path B unit 500, OFF is changed into ON on the seventh SF, the second SF, and the first SF (7SF, 2SF, and 1SF) in the sixth pixel from the left (X6: tone 64) in FIG. 28. This is equivalent to the change of the number of tones from 64 to 87. By this means, in the sixth pixel from the left (X6), brightness to be recognized is improved from 40 to 63. More specifically, the edge portion is recognized clearly.

Further, FIG. 31 shows the case where the image area moves by four pixels in one field in the right direction in the same manner as that in FIG. 29. Although brightness to be recognized is 15, 15, 12, 40, 40, 64, 64 from the left side in FIG. 29, by selecting the process of the sub path B unit 500 in FIG. 31, OFF is changed into ON on the seventh SF, the second SF, and the first SF (7SF, 2SF, and 1SF) in the sixth pixel from the left (X6: tone 64) in FIG. 29. By this means, brightness to be recognized is improved so as to be 15, 15, 15, 40, 60, 64, 64 from the left side.

<Control (2-2)>

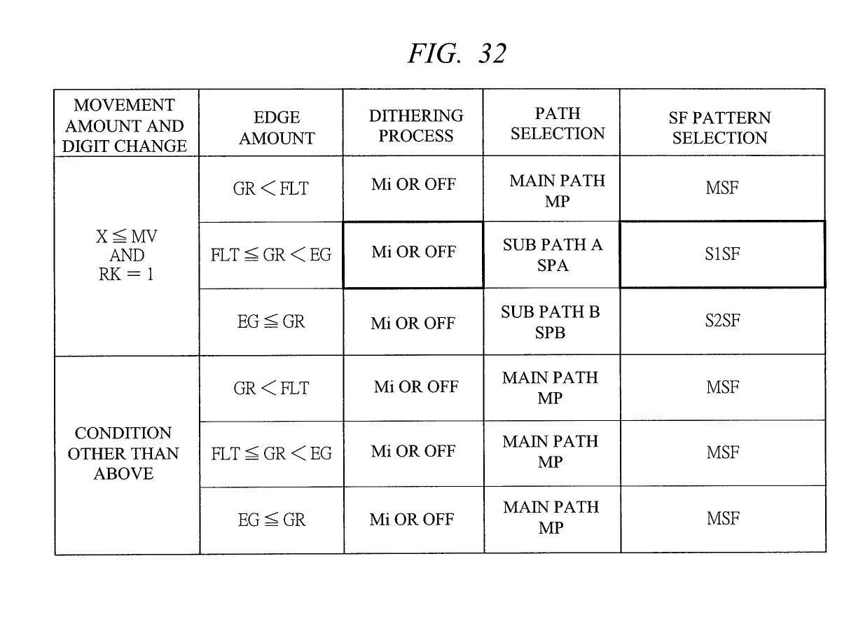

Next, FIG. 32 shows the control of the switching of processes in a modified example (second structure) of the second embodiment in the same manner as that in FIG. 7. In this control, when the edge amount GR is FLT or more and less than EG, modulation process by modulation amount Mi or OFF may be performed in the dithering process, and the sub path A is selected in the path selection, and also, images are expressed by the use of S1SF in the SF pattern selection. Conditions other than the above are the same as those in the case of FIG. 7.

As described above, according to the second embodiment, switching to an appropriate path is made especially in accordance with the edge amount GR. Therefore, it is possible to reduce or prevent false contours and the like in accordance with various gradation inclinations when moving images are displayed, and thus, the image quality can be improved.

### Third Embodiment

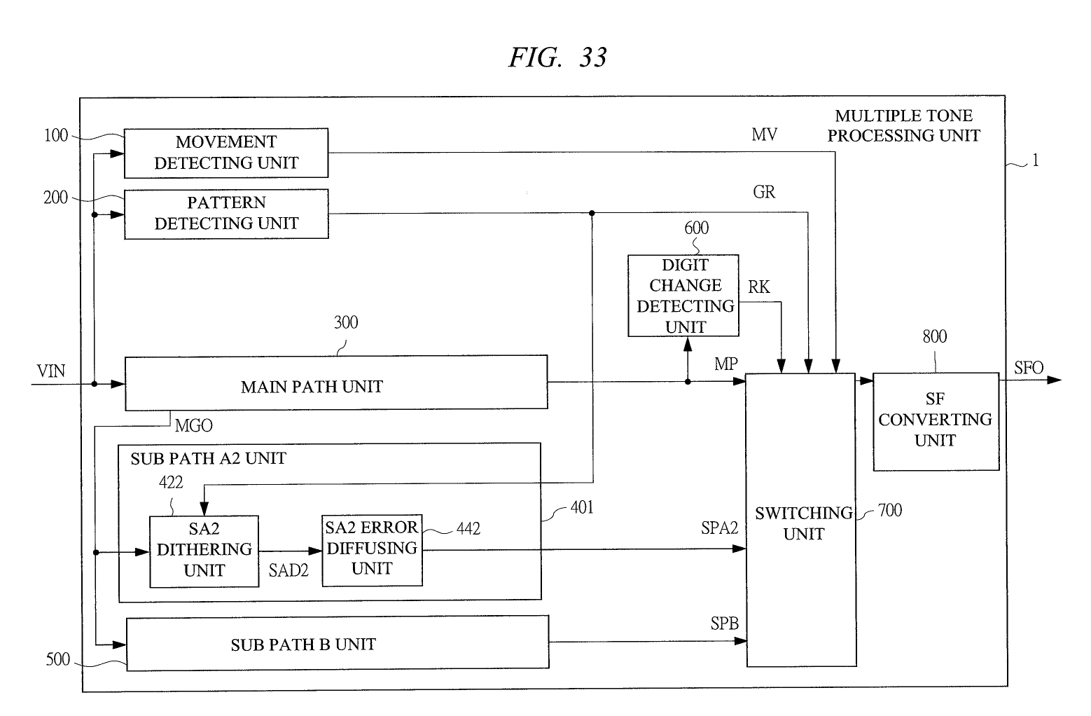

A third embodiment will be described below with reference to FIG. 33 to FIG. 37 and others. The feature of the third embodiment lies in that paths of plural processes are switched in the same manner as that in the second embodiment and a process in accordance with the edge amount GR is executed in the first sub path.

<Multiple Tone Processing Unit (3)>

The outline of the structure of the multiple tone processing unit 1 according to the third embodiment will be described with reference to FIG. 33. In this structure, as a different component, a sub path A2 unit (first sub path unit) 401 which is a modified example of the sub path A unit 400 of the second embodiment is provided. As the process of the first sub path, the sub path A2 unit 401 inputs MGO and GR of the output of the pattern detecting unit 200 and outputs a signal SPA2 obtained by the modulation processes with a modulation amount M changed depending on GR.

The transition of the data conversion in the main path, the sub path A2 (first sub path), the sub path B (second sub path) according to the third embodiment is similar to that in FIG. 8.

<Control (3-1)>

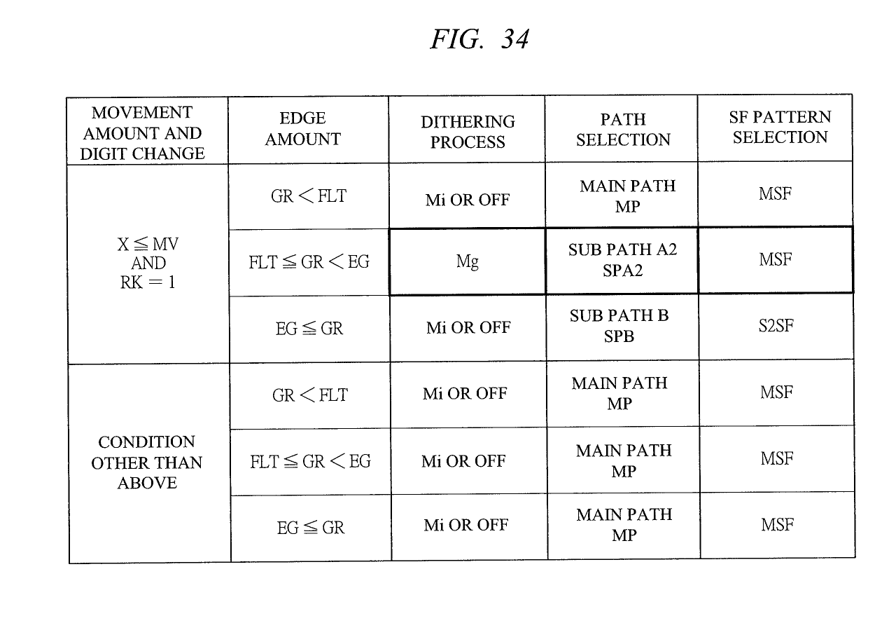

Next, FIG. 34 shows the control of the switching of processes in the multiple tone processing unit 1 of the third embodiment. In this control, when the edge amount GR is FLT or more and less than EG, modulation process by modulation amount Mg is performed in the dithering process, the sub path A2 is selected in the path selection, and images are expressed by the use of MSF in the SF pattern selection. Conditions other than the above are the same as those in the control in the second embodiment.

<Sub Path A2-1>

Next, the structure of the sub path A2 unit 401 of the multiple tone processing unit 1 will be described with reference to FIG. 33. The sub path A2 unit 401 includes an SA2 dithering unit 422 and an SA2 error diffusing unit 442.

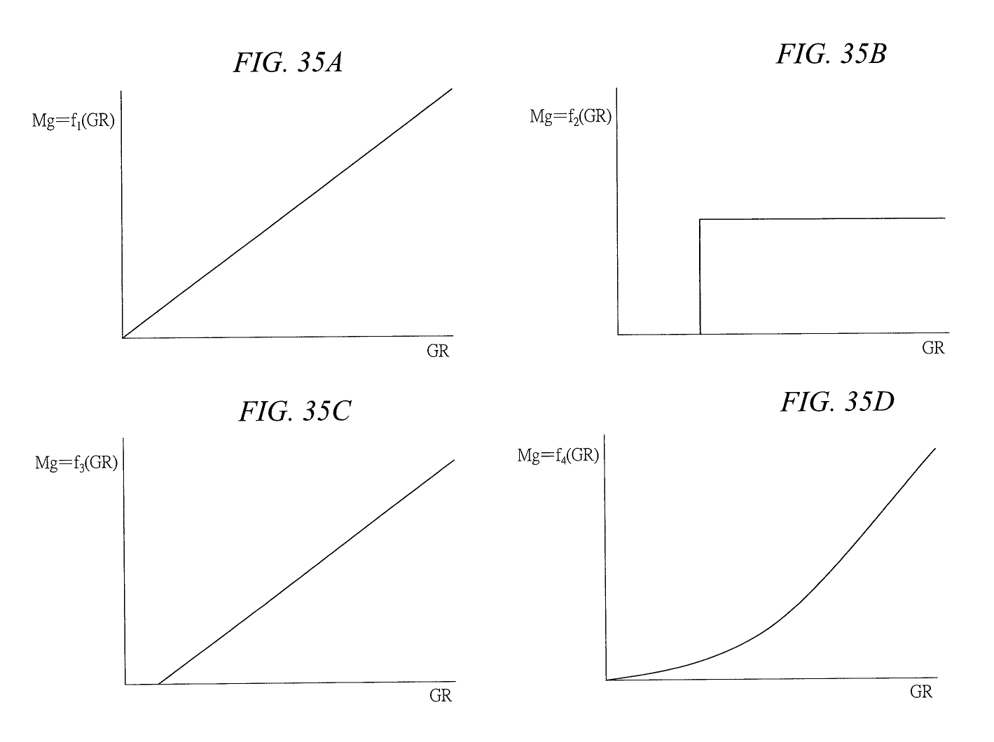

The SA2 dithering unit 422 inputs MGO and GR from the pattern detecting unit 200 and outputs a signal SAD2 obtained by the modulation by the dithering process. In this modulation by the dithering process, modulation coefficient is changed in accordance with GR as shown in FIG. 35, and the dithering setting value is selected in accordance with an input value as shown in FIG. 19, and calculation is made by using the modulation coefficient and the dithering setting value.

The SA2 error diffusing unit 442 inputs the output SAD2 of the SA2 dithering unit 422 and outputs the signal SPA2 with 87 tones. The output value corresponds to the column MK in FIG. 8.

<Sub Path A2-2>

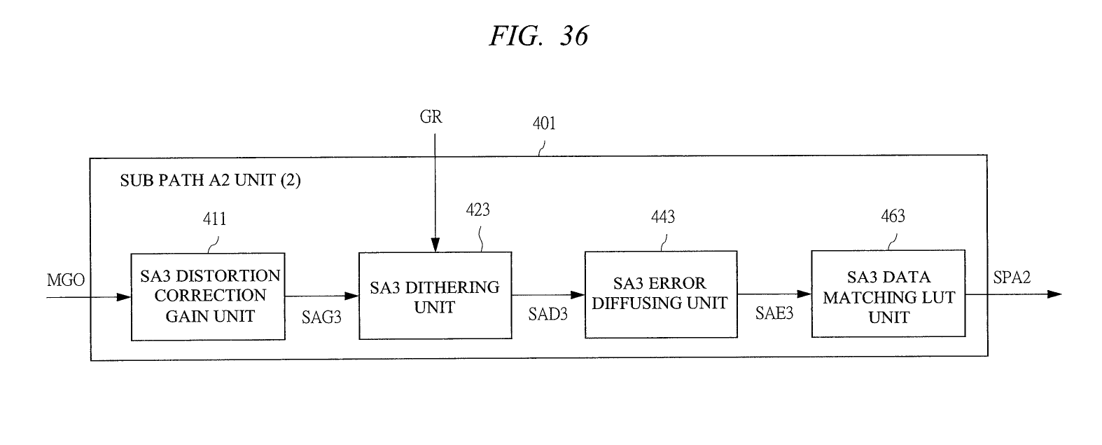

Next, a modified example (second structure) of the sub path A2 unit 401 will be described with reference to FIG. 36. The sub path A2 unit (2) 401 includes an SA3 distortion correction gain unit 411, an SA3 dithering unit 423, an AS2 error diffusing unit 443, and an SA3 data matching LUT unit 463. When compared to the sub path A2 unit 401, the sub path A2 unit (2) 401 has a structure in which a distortion correction gain unit (411) and a data matching LUT unit (463) are additionally provided.

The SA3 distortion correction gain unit 411 inputs MGO, applies a specified gain thereto, and then outputs an output signal SAG3. The circuit thereof is the same as that of the SA1 distortion correction gain unit 410. The gain characteristics of the SA3 distortion correction gain unit 411 are the same as those in FIG. 10.

The SA3 dithering unit 423 inputs the output SAG3 of the SA3 distortion correction gain unit 411 and GR from the pattern detecting unit 200 and outputs a signal SAD3 obtained by the modulation by the dithering process. The circuit thereof is the same as that of the SA2 dithering unit 422.

The SA3 error diffusing unit 443 inputs the output SAD3 of the SA3 dithering unit 423 and performs the error diffusing process to output a 6-bit signal SAE3 with the number of tones of 42. The circuit thereof is the same as the SA1 error diffusing unit 441.

The SA3 data matching LUT unit 463 inputs the output SAE3 of the SA3 error diffusing unit 443 and outputs a signal SPA2. The output value is S1K in FIG. 8 and the circuit thereof is the same as that of the SA1 data matching LUT unit 460.

<SA2 Dithering Unit>

Next, the structure of the SA2 dithering unit 422 in the sub path A2 unit 401 is the same as that in FIG. 17. In the dithering amount calculating unit 339 of the SA2 dithering unit 422, only GR among MV, GR, RK is inputted. This can be obtained by the structure where MV=0 and RK=0 are inputted. The dithering amount calculating unit 339 calculates and outputs the dithering amount (M) by the use of GR to the dithering coefficient inputted from the dithering coefficient selecting unit 332.

FIG. 35 shows the relation between the edge amount GR and the modulation amount Mg in the SA2 dithering unit 422 of the sub path A2 unit 401. In FIG. 35A, the relation of the modulation coefficient Mg of dithering process to the edge amount GR is in the shape of linear function. In FIG. 35B, the modulation coefficient Mg is 0 when the edge amount is below a specified edge amount and the modulation coefficient Mg becomes a specified fixed value when the edge amount is over the specified edge amount. In FIG. 35C, the relation of the modulation coefficient Mg to the edge amount GR is in the shape of linear function whose intercept is a negative number. In FIG. 35D, the relation of the modulation coefficient Mg to the edge amount GR is in the shape of an index function. In any of the above, Mg is expressed by the function of the edge amount GR: f(GR).

<Control (3-2)>

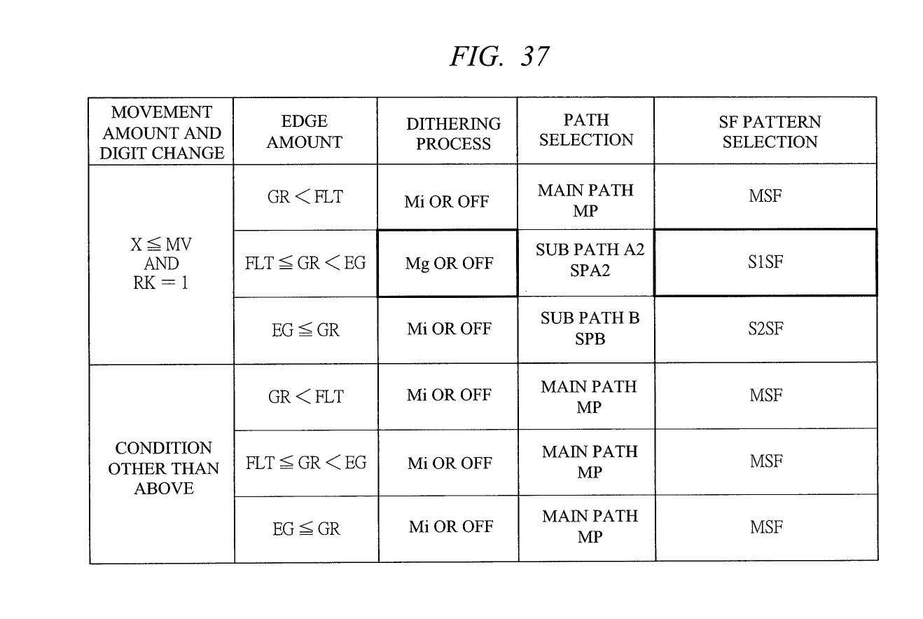

Next, FIG. 37 similarly shows the control of the switching of processes in a modified example (second structure) of the third embodiment. In this control, when the edge amount GR is FLT or more and less than EG, modulation process by modulation amount Mg or OFF may be performed in the dithering process, the sub path A2 is selected in the path selection, and images are expressed by the use of S1SF in the SF pattern selection. Conditions other than the above are the same as those in FIG. 32.

As described above, according to the third embodiment, since modulation process is performed with changing the modulation amounts especially in accordance with the edge amount GR, it is possible to reduce or prevent false contours and the like in accordance with various gradations when moving images are displayed, and the image quality can be improved.

### Fourth Embodiment

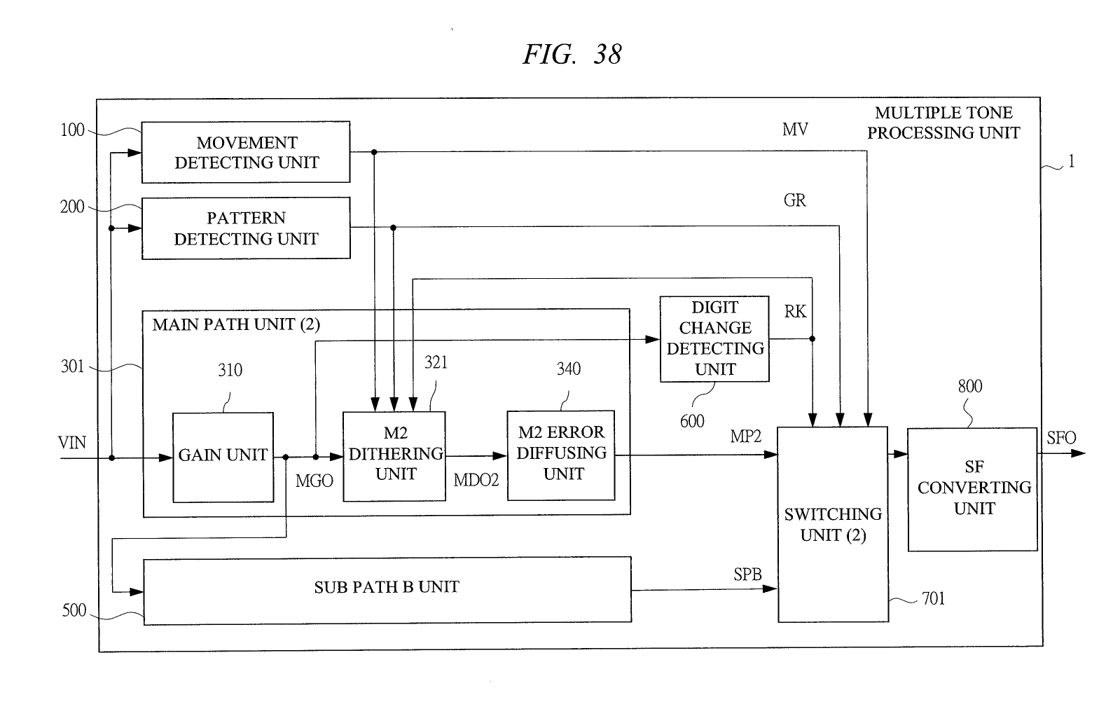

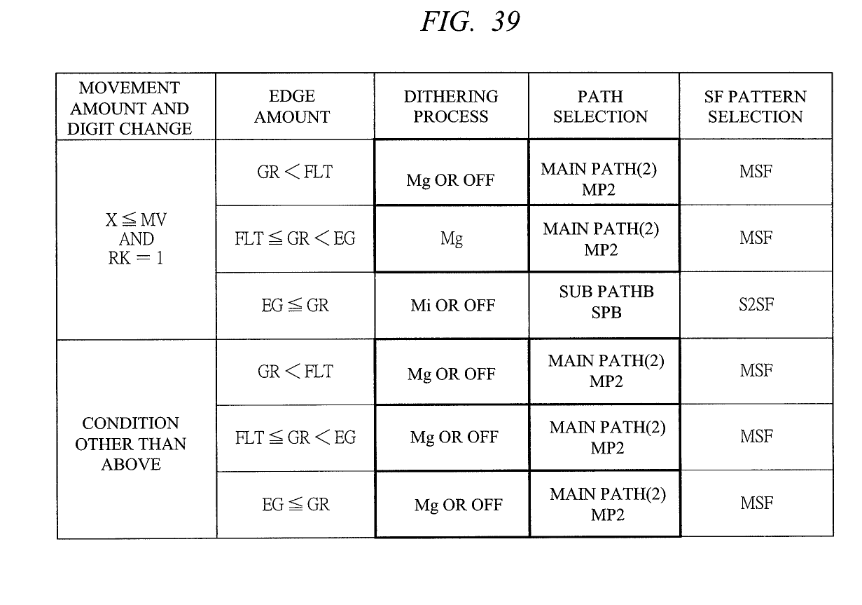

A fourth embodiment will be described below with reference to FIG. 38 and FIG. 39 and others. The feature of the fourth embodiment lies in that paths of plural processes are switched in the same manner as that in the second embodiment and a process in accordance with MV, GR, and RK is performed in the main path.

<Multiple Tone Processing Unit (4)>

The outline of the structure of the multiple tone processing unit 1 according to the fourth embodiment will be described with reference to FIG. 38. In this structure, the sub path A unit 400 of the second embodiment is not provided, but a main path unit (2) 301 of a structure (second structure) different from the main path unit 300 is provided. As the process of the main path (2), the main path unit (2) 301 inputs the input image signal VIN, the output MV of the movement detecting unit 100, the output GR of the pattern detecting unit 200, and the output RK of the digit change detecting unit 600, outputs a signal MP2 obtained by multiple tone process to a switching unit (2) 701, and outputs the signal MGO with the same number of tones as MP2 to the digit change detecting unit 600. When MV is a specified value or more and RK is “1”, the main path unit (2) 301 performs modulation process with the modulation amount M calculated on the basis of GR.

<Control (4)>

Next, the control of the switching of processes in the multiple tone processing unit 1 of the fourth embodiment is shown in FIG. 39. In this control, when a movement amount MV in a display objective image is a specified value X or more and an edge amount GR is smaller than a specified value FLT in the pixel where a carry is detected (RK=1), that is, in the case of a flat portion, modulation process with a modulation amount Mg or OFF may be performed in the dithering process, and the main path (2) is selected in the path selection, and also, images are expressed by the use of MSF in the SF pattern selection. Also, when the edge amount GR is FLT or more and less than EG, that is, in the case of a gradation, modulation process with Mi is performed in the dithering process, and the main path (2) is selected in the path selection, and images are expressed by MSF in the SF pattern selection. Further, when the edge amount GR is EG or more, that is, in the case of an edge portion, modulation process with a modulation amount Mi or OFF may be performed in the dithering process, and the sub path B is selected in the path selection, and images are expressed by the use of S2SF in the SF pattern selection. When the detection results of the movement amount and the carry are other than the above, any of the modulation with Mg and OFF can be performed in the dithering process, and the main path (2) is selected in the path selection, and images are expressed by the use of MSF in the SF pattern selection.

<Main Path-2>

Next, the structure of the main path unit (2) 301 of the multiple tone processing unit 1 will be described with reference to FIG. 38. The main path unit (2) 301 includes a gain unit 310, an M2 dithering unit 321, and an M error diffusing unit 340.

The M2 dithering unit 321 inputs the output MV of the movement detecting unit 100, the output GR of the pattern detecting unit 200, and the output RK of the digit change detecting unit 600 and outputs a signal MDO2 obtained by the modulation process with the modulation amount M. In the modulation process by dithering process in the M2 dithering unit 321, modulation process is performed for the area of a pixel where movement amount MV is a specified value or more and RK is “1”. The modulation amount M is calculated from the modulation coefficient calculated on the basis of GR as shown in FIG. 35 and the dithering amount relative to the input value as shown in FIG. 19. Further, the main path unit (2) 301 outputs a signal MGO from the main unit 310. The output value of the main path unit (2) 301 corresponds to the column MK in FIG. 8.

The structure of the M2 dithering unit 321 in the main path unit (2) 301 is the same as that in FIG. 17. The dithering amount calculating unit 339 of the M2 dithering unit 321 has the same function as that of the dithering amount calculating unit 339 of the SA2 dithering unit 422 in the third embodiment, but it inputs all of MV, GR, and RK. The dithering amount calculating unit 339 inputs the output of the dithering coefficient selecting unit 332, MV, GR, and RK and outputs the dithering amount (M).

As described above, according to the fourth embodiment, modulation process is performed while changing the modulation amounts especially in accordance with the edge amount GR in the main path. Therefore, it is possible to reduce or prevent false contours and the like in accordance with various gradations when moving images are displayed, and the image quality can be improved.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be applied to a display system such as a PDP system in which multiple tone data is processed and displayed on a display system.

What is claimed is:

1. A multiple tone display system, in which a field corresponding to a display area and period by pixels in a display panel is divided into a plurality of sub fields weighted with brightness, and multiple-tone moving images are displayed on said display panel by encoding into combinations of lighting ON/OFF in unit of said sub field in accordance with tones of pixels of said field on the basis of input image signals,
said display system comprising:
means for comparing fields of said input image signals and detecting and outputting a movement part and a movement amount showing a size thereof;
means for comparing pixel values of adjacent pixels of said input image signals and detecting and outputting an edge amount showing a size of inclination of gradation;
means for detecting a digit change where one of pixel values of adjacent pixels of said input image signals is smaller than a specified first tone and the other thereof is said first tone or more and outputting a digit change signal expressing it at least in the pixel in which the digit change is detected and peripheral pixels thereof;
signal processing means for selecting and executing a process from a plurality of processes for reducing the false contours in said moving image in accordance with said edge amount on the basis of said movement amount, said edge amount, and said digit change signal, when said movement amount is a specified value or more and said digit change signal is a value showing presence of a digit change; and
means for inputting the output of said signal processing means and converting the output into data of said encoding in accordance with a specified table, and then outputting the data to said display panel.

2. A multiple tone display system, in which a field corresponding to a display area and period by pixels in a display panel is divided into a plurality of sub fields weighted with brightness, and multiple-tone moving images are displayed on said display panel by encoding into combinations of lighting ON/OFF in unit of said sub field in accordance with tones of pixels of said field on the basis of input image signals,
said display system comprising:
means for comparing fields of said input image signals and detecting and outputting a movement part and a movement amount showing a size thereof;
means for comparing pixel values of adjacent pixels of said input image signals and detecting and outputting an edge amount showing a size of inclination of gradation;
main path means for inputting said input image signals and outputting, as a main path, a first image signal obtained by multiple tone process;
first sub path means for inputting said input image signals and outputting, as a first sub path, a second image signal obtained by modulation process;
second sub path means for inputting said input image signals and outputting, as a second sub path, a third image signal with a smaller number of tones than said main path;
means for inputting said first image signal of said main path, detecting a digit change where one of pixel values of adjacent pixels is smaller than a specified first tone and the other thereof is said first tone or more, and outputting a digit change signal expressing it at least in the pixel in which the digit change is detected and peripheral pixels thereof;
switching means for inputting said movement amount, said edge amount, and said digit change signal, and switching and outputting one of said first to third image signals on the basis of them; and
means for inputting the output of said switching means, converting the output into data of said encoding in accordance with a specified table, and outputting the data to said display panel,
wherein said switching means selects said third image signal under a first condition where said movement amount is a specified value or more, said digit change signal is a value showing presence of a digit change, and said edge amount is a first threshold value or more,
said switching means selects said second image signal under a second condition where said movement amount is a specified value or more, said digit change signal is a value showing presence of a digit change, and said edge amount is a second threshold value or more and less than said first threshold value, and
said switching means selects said first image signal in a case other than said first and second conditions.

3. The multiple tone display system according to claim 2,
wherein said first sub path means performs said modulation process by a dithering process.

4. The multiple tone display system according to claim 2,
wherein said first sub path means performs said modulation process by an error diffusing process.

5. The multiple tone display system according to claim 4,
wherein said first sub path means includes means for performing a distortion correction gain process and means for performing a data matching lookup table process.

6. A multiple tone display system, in which a field corresponding to a display area and period by pixels in a display panel is divided into a plurality of sub fields weighted with brightness, and multiple-tone moving images are displayed on said display panel by encoding into combinations of lighting ON/OFF in unit of said sub field in accordance with luminance of pixels of said field on the basis of input image signals,
said display system comprising:
means for comparing fields of said input image signals and detecting and outputting a movement part and a movement amount showing a size thereof;
means for comparing pixel values of adjacent pixels of said input image signals and detecting and outputting an edge amount showing a size of inclination of gradation;
main path means for inputting said input image signals and outputting, as a main path, a first image signal obtained by multiple tone process;
first sub path means for inputting said input image signals and said edge amount and outputting, as a first sub path, a second image signal obtained by modulation process performed while changing modulation amount in accordance with said edge amount;
second sub path means for inputting said input image signals and outputting, as a second sub path, a third image signal with a smaller number of tones than said main path;
means for inputting said first image signal outputted from said main path, detecting a digit change where one of pixel values of adjacent pixels is smaller than a specified first tone and the other thereof is said first tone or more, and outputting a digit change signal expressing it at least in the pixel in which the digit change is detected and peripheral pixels thereof;
switching means for inputting said movement amount, said edge amount, and said digit change signal, and switching and outputting one of said first to third image signals on the basis of them; and
means for inputting the output of said switching means, converting the output into data of said encoding in accordance with a specified table, and outputting the data to said display panel,
wherein said switching means selects said third image signal under a first condition where said movement amount is a specified value or more, said digit change signal is a value showing presence of a digit change, and said edge amount is a first threshold value or more,
said switching means selects said second image signal under a second condition where said movement amount is a specified value or more, said digit change signal is a value showing presence of a digit change, and said edge amount is a second threshold value or more and less than said first threshold value, and
said switching means selects said first image signal in a case other than said first and second conditions.

7. The multiple tone display system according to claim 6,
wherein said first sub path means performs said modulation process by a dithering process.

8. A multiple tone display system, in which a field corresponding to a display area and period by pixels in a display panel is divided into a plurality of sub fields weighted with brightness, and multiple-tone moving images are displayed on said display panel by encoding into combinations of lighting ON/OFF in unit of said sub field in accordance with luminance of pixels of said field on the basis of input image signals,
said display system comprising:
means for comparing fields of said input image signals and detecting and outputting a movement part and a movement amount showing a size thereof;
means for comparing pixel values of adjacent pixels of said input image signals and detecting and outputting an edge amount showing a size of inclination of gradation;
means for detecting a digit change where one of pixel values of adjacent pixels is smaller than a specified first tone and the other thereof is said first tone or more, and outputting a digit change signal expressing it at least in the pixel in which the digit change is detected and peripheral pixels thereof;
main path means for inputting said input image signals, said movement amount, said edge amount, and said digit change signal and outputting, as a main path, a first image signal obtained by a multiple tone process and a modulation process with a modulation amount in accordance with said edge amount when said movement amount is a specified value or more and said digit change signal is a value showing presence of a digit change,
sub path means for inputting said input image signals and outputting, as a sub path, a second image signal with a smaller number of tones than said main path;
switching means for inputting said movement amount, said edge amount, and said digit change signal and switching and outputting one of said first and second image signals on the basis of them; and
converting means for inputting the output of said switching means and converting the output into data of said encoding in accordance with a specified table, and then outputting the data to said display panel,
wherein said switching means selects said second image signal under a first condition where said movement amount is a specified value or more, said digit change signal is a value showing presence of a digit change, and said edge amount is a first threshold value or more, and
said switching means selects said first image signal in a case other than said first condition.

9. The multiple tone display system according to claim 8,
wherein said means for outputting said digit change signal inputs a signal with the same number of tones as the number of tones to be converted by said converting means.

10. The multiple tone display system according to claim 8,
wherein said main path means performs said modulation process by a dithering process.

11. A multiple tone display system, in which a field corresponding to a display area and period by pixels in a display panel is divided into a plurality of sub fields weighted with brightness, and multiple-tone moving images are displayed on said display panel by encoding into combinations of lighting ON/OFF in unit of said sub field in accordance with tones of pixels of said field on the basis of input image signals,
said display system comprising:
means for comparing fields of said input image signals and detecting and outputting a movement part and a movement amount showing a size thereof;
means for comparing pixel values of adjacent pixels of said input image signals and detecting and outputting an edge amount showing a size of inclination of gradation;
main path means for inputting said input image signals and outputting, as a main path, a first image signal obtained by multiple tone process;
first sub path means for inputting said input image signals and outputting, as a first sub path, a second image signal obtained by modulation process;
second sub path means for inputting said input image signals and outputting, as a second sub path, a third image signal with a smaller number of tones than said main path;
switching means for inputting said movement amount and said edge amount, and switching and outputting one of said first to third image signals on the basis of them; and
means for inputting the output of said switching means, converting the output into data of said encoding in accordance with a specified table, and outputting the data to said display panel,
wherein said switching means selects said third image signal under a first condition where said movement amount is a specified value or more and said edge amount is a first threshold value or more,
said switching means selects said second image signal under a second condition where said movement amount is a specified value or more and said edge amount is a second threshold value or more and less than said first threshold value, and
said switching means selects said first image signal in a case other than said first and second conditions.
